(19) United States
(12) Patent Application Publication
(10) Pub. No.: US 2014/0337134 A1
(43) Pub. Date: Nov. 13, 2014

(54) Federated E-Commerce System and Method

(71) Applicant: CenturyLink Intellectual Property LLC, Denver, CO (US)

(72) Inventor: Michael K. Bugenhagen, Overland Park, KS (US)

(73) Assignee: CenturyLink Intellectual Property LLC, Denver, CO (US)

(21) Appl. No.: 14/044,064

(22) Filed: Oct. 2, 2013

Related U.S. Application Data
(60) Provisional application No. 61/821,081, filed on May 8, 2013.

(51) Int. Cl. G06Q 10/08

(52) U.S. Cl. CPC G06Q 10/087
USPC 705/14.57; 705/28; 705/14.73; 705/26.62

(57) ABSTRACT

Novel tools and techniques are provided for providing and operating a federated e-commerce network. In some embodiments, a standard database is provided for local providers, stores, or retailers to automatically reflect their supply levels and price in order to facilitate providing a national-level or international-level type e-commerce experience for the local providers, stores, or retailers. A website might be established or maintained that provides local retailers with control over sale of items, while allowing customers to search and purchase items listed in a consolidated inventory list compiling inventory information from databases associated with two or more local retailers in the federated e-commerce network. Customers may also be provided with options to create, modify, or delete wish lists, hate lists, and/or gift lists. Ads may automatically be generated based on one or more of viewing or buying patterns, the wish lists, the hate lists, or gift lists associated with each customer.

### CROSS-REFERENCES TO RELATED APPLICATIONS

This application claims priority to U.S. Patent Application Ser. No. 61/821,081 (the “'081 application”), filed May 8, 2013 by Michael K. Bugenhagen (attorney docket no. 020370-006701US), entitled, “Federated E-Commerce System,” the entire disclosure of which is incorporated herein by reference in its entirety for all purposes.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD

The present disclosure relates, in general, to a method and system for providing and operating a federated e-commerce network.

### BACKGROUND

Traditionally, local e-commerce has been restricted by the availability of local stocking and pricing information from local resources. Large e-commerce organizations (such as Amazon.com, Inc.) focus on regional warehouses. Although some mobile software applications (“mobile apps”) for such organizations might use local pricing information, such mobile apps for such organizations typically do not contain stocking information for local supply levels. A problem with such organizations tracking local stocking information is that each local store typically has its own stocking inventory solution, and thus is not databased in a similar fashion as such organizations, i.e., on a secure network.

Hence, there is a need for more robust and scalable e-commerce solutions.

### BRIEF SUMMARY

Various embodiments provide techniques for providing and operating a federated e-commerce network. In some instances, a standard database is provided for local providers, stores, or retailers to automatically reflect their supply levels and prices in order to facilitate providing a national-level or international-level-type e-commerce experience for the local providers, stores, or retailers.

A system might also be provided that enables local business owners to be part of an Amazon.com-like Internet sales system by having local service providers (such as CenturyLink or the like) offer a small business cataloging service interface so that Amazon.com or similar companies can federate the brick and mortar store inventory for another sales channel, and let the local business owners choose where and what they wish to sell. In a set of models, local service providers (e.g., CenturyLink or the like) might also provide a local sales search engine and “home market”-based small business service help and training over layer 1 and/or 2 of the Open Systems Interconnection (“OSI”) framework architecture.

Certain embodiments, therefore, can essentially outsource the Internet sales channel by both the small business, and large sales organizations like Amazon.com via a federated universal sales and advertising database channel. None of this exists to date. In an aspect, some embodiments might even couple a federated universal sales and advertising database channel system with delivery services such as the US postal service and outsource delivery as well, all in an automated fashion. Likewise, the federated universal sales and advertising database channel system can be coupled with banking networks, such as Visa card swipe machines or other suitable payment networks, as well as with other e-commerce networks.

The tools provided by various embodiments include, without limitation, methods, systems, and/or software products. Merely by way of example, a method might comprise one or more procedures, any or all of which might be executed by a computer system. Correspondingly, an embodiment might provide a computer system configured with instructions to perform one or more procedures in accordance with methods provided by various other embodiments. Similarly, a computer program might comprise a set of instructions that are executable by a computer system, or by a processor located in the computer system, to perform such operations. In many cases, such software programs are encoded on physical, tangible, and/or non-transitory computer readable media. Such computer readable media might include, to name but a few examples, optical media, magnetic media, and the like.

In an aspect, a federated e-commerce network system might be provided. The system might comprise a federated e-commerce server operated by a federated e-commerce provider in a federated e-commerce network, a regional database located in the federated e-commerce network and communicatively coupled to the federated e-commerce server, a first e-commerce network interface device (“NID”) among a plurality of e-commerce NIDs, and a second e-commerce NID among the plurality of e-commerce NIDs. The federated e-commerce server might comprise one or more computers, each comprising one or more processors and a set of instructions executable by the one or more processors to perform one or more operations.

The first e-commerce NID might comprise one or more network interfaces and might be configured to provide communication between a first merchant computer and the federated e-commerce server over the federated e-commerce network. The first merchant computer might be located at a first retail location operated by a first merchant and might comprise a first merchant database that tracks inventory of the first retail location.

The second e-commerce NID might be configured to provide communication between a second merchant computer and the federated e-commerce server over the federated e-commerce network. The second merchant computer might be located at a second retail location operated by a second merchant and might comprise a second merchant database that tracks inventory of the second retail location.

The set of instructions might comprise instructions to automatically update the regional database, in response to inventory updates being performed by at least one of the first merchant database or the second merchant database.

In some embodiments, one or more of the federated e-commerce server, the first e-commerce NID, or the second e-commerce NID might perform one or more gateway functions that provide data transfer between the regional database and one or more of the first merchant database or the second merchant database. The one or more gateway functions might comprise one or more of synchronizing data roles between the regional database and one or more of the first merchant database or the second merchant database, translating a local retailer inventory system of one or more of the first merchant computer or the second merchant computer into inventory objects at one or more of the federated e-commerce server or the regional database, accepting manual input of inventory items by one or more of the first merchant or the second merchant, performing logical rules checks on the data prior to data transfer, facilitating handling of audit rejections by one or more of the first merchant or the second merchant, providing a question and answer portal to allow exchange of information regarding inventory, or providing access to a shared sales database located in the federated e-commerce network. The shared sales database can be one of the regional database or a database separate from the regional database. In one embodiment, one or more inventory items stored in the regional database and one or more of the first merchant database or the second merchant database might each comprise a hash tag provided by one or more of the first merchant or second merchant that indicates the subject inventory item as a specialty item and how the subject inventory item is useful for a particular specialty area. The hash tag allows products to be grouped into a search query, and the text behind the hashtag informs the searcher as to how that product is useful for that specialty area. This could be locally relevant terminology, or simply a product that is used outside of its normal area of use.

According to some embodiments, the set of instructions might further comprise instructions to determine whether inventory of the first retail location has changed, instructions to poll a first retailer inventory system of the first merchant computer in response to a determination that the inventory of the first retail location has changed, and instructions to store inventory changes in the regional database based on results of said polling. The set of instructions might further comprise instructions to determine whether inventory of the second retail location has changed, instructions to poll a second retailer inventory system of the second merchant computer in response to a determination that the inventory of the second retail location has changed, and instructions to store inventory changes in the regional database based on results of said polling.

In some cases, the set of instructions might further comprise instructions to establish or maintain a website integrating inventory information stored in the first merchant database and in the second merchant database, and instructions to provide a consumer having access to the website with tools to search consolidated inventory information corresponding to the inventory information stored in the first merchant database and in the second merchant database. The consolidated inventory information might be stored in the regional database. The set of instructions might further comprise instructions to provide the consumer with tools to purchase, via the website, one or more merchandise items listed in the consolidated inventory information stored in the regional database, and instructions to update each of the regional database, the first merchant database, and the second merchant database based on the purchase of the one or more merchandise items via the website

The set of instructions, in some instances, might further comprise instructions to provide communication between the federated e-commerce server and one or more payment networks, and instructions to provide the consumer with payment options associated with the one or more payment networks during purchasing of the one or more merchandise items. The one or more payment networks might include at least one of banking networks, online payment networks, or charge card networks.

In some cases, the set of instructions might comprise instructions to provide retailer control to each of the first merchant and the second merchant via the federated e-commerce network. The retailer control might include at least one of changing a sales status of each of the one or more merchandise items listed in the inventory information to indicate whether said each of the one or more merchandise items is a sale item that is available for sale on the website, changing a sale price for each sale item on the website, changing a promotion status of each sale item to indicate whether said each sale item is to be advertised as being one of a discounted item, a clearance item, a best value item, or a featured item. The set of instructions might further comprise instructions to generate advertisements based on at least one of the sales status, the sale price, or promotion status of each sale item, and to distribute the generated advertisements along one or more advertising channels based on geographic location of each retail location associated with each sale item.

In some embodiments, the set of instructions might further comprise instructions to identify customer pattern information associated with each customer, based on buying and viewing patterns of each customer on the website, and instructions to store the customer pattern information associated with each customer in the regional database. The set of instructions might further comprise instructions to provide each customer with options to create, modify, or delete at least one of one or more wish lists, one or more hate lists, or one or more gift lists, and instructions to generate targeted advertisement for each customer, based on at least one of the customer pattern information, the one or more wish lists, the one or more hate lists, or the one or more gift lists associated with each customer.

The set of instructions, according to some embodiments, might further comprise instructions to provide communication between the federated e-commerce server and one or more national or international e-commerce servers associated with one or more national or international e-commerce retailers via one or more national or international e-commerce networks. Each of the one or more national or international e-commerce servers might be configured to establish or maintain a national or international e-commerce website. The set of instructions might further comprise instructions to send the consolidated inventory information stored in the regional database to the one or more national or international e-commerce servers for presentation and searching, on the national or international e-commerce website, of the one or more merchandise items listed in the consolidated inventory information.

In another aspect, a method for providing federated e-commerce functionality among a plurality of retail locations operated by a plurality of merchants might be provided. The method might comprise providing, with a first e-commerce network interface device (“NID”) among a plurality of e-commerce NIDs, communication between a first merchant computer and a federated e-commerce server over a federated e-commerce network, and providing, with a second e-commerce NID among the plurality of e-commerce NIDs, communication between a second merchant computer and the federated e-commerce server over the federated e-commerce network. The first merchant computer might be located at a first retail location among the plurality of retail locations, the first retail location being operated by a first merchant among the plurality of merchants. The first merchant computer might comprise a first merchant database that tracks inventory of the first retail location, the federated e-commerce server being operated by a federated e-commerce provider or broker. The second merchant computer might be located at a second retail location among the plurality of retail locations, the second retail location being operated by a second merchant among the plurality of merchants. The second merchant computer might comprise a second merchant database that tracks inventory of the second retail location.

The method might further comprise automatically updating, with the federated e-commerce server, a regional database that is communicatively coupled to the federated e-commerce server, in response to inventory updates being performed by at least one of the first merchant database or the second merchant database. The regional database might be located in the federated e-commerce network.

In some embodiments, one or more of the federated e-commerce server, the first e-commerce NID, or the second e-commerce NID might perform one or more gateway functions that provide data transfer between the regional database and one or more of the first merchant database or the second merchant database. The one or more gateway functions might comprise one or more of synchronizing data between the regional database and one or more of the first merchant database or the second merchant database, translating a local retailer inventory system of one or more of the first merchant computer or the second merchant computer into inventory objects at one or more of the federated e-commerce server or the regional database, accepting manual input of inventory items by one or more of the first merchant or the second merchant, performing logical rules checks on the data prior to data transfer, facilitating handling of audit rejections by one or more of the first merchant or the second merchant, providing a question and answer portal to allow exchange of information regarding inventory, or providing access to a shared sales database located in the federated e-commerce network. The shared sales database can be one of the regional database or a database separate from the regional database.

According to some embodiments, the first merchant database might have stored thereon local pricing information for each item of merchandise listed in the inventory of the first retail location, while the second merchant database might have stored thereon local pricing information for each item of merchandise listed in the inventory of the second retail location.

In yet another aspect, an e-commerce network interface device (“NID”) might be provided. The e-commerce NID might comprise a processor, one or more network interfaces, and a non-transitory computer readable medium having stored thereon a set of instructions executable by the processor to perform one or more operations. The set of instructions might comprise instructions to provide communication between a first merchant computer and a federated e-commerce server over the federated e-commerce network. The first merchant computer might be located at a first retail location among the plurality of retail locations, the first retail location being operated by a first merchant among a plurality of merchants. The first merchant computer might comprise a first merchant database that tracks inventory of the first retail location, the federated e-commerce server being operated by the federated e-commerce provider. The set of instructions might further comprise instructions for sending inventory updates of the first retail location to the federated e-commerce server over the federated e-commerce network, in response to a determination that inventory of the first retail location has changed.

Various modifications and additions can be made to the embodiments discussed without departing from the scope of the invention. For example, while the embodiments described above refer to particular features, the scope of this invention also included embodiments having different combination of features and embodiments that do not include all of the above described features.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. In some instances, a sub-label is associated with a reference numeral to denote one of multiple similar components. When reference is made to a reference numeral without specification to an existing sub-label, it is intended to refer to all such multiple similar components.

FIG. 1 is a general schematic diagram illustrating a system for providing and operating a federated e-commerce network, in accordance with various embodiments.

FIG. 2 is a general schematic flow diagram illustrating a method for implementing automatic updates of a regional database based on inventory updates of local retail databases using a federated e-commerce network system, in accordance with various embodiments.

FIG. 3 is a general schematic flow diagram illustrating a method for implementing an e-commerce website with which a consumer can interact to search for and purchase merchandise items across local retailer inventories within a federated e-commerce network system, in accordance with various embodiments.

FIG. 4 is a general schematic flow diagram illustrating a method for providing retailer control over an e-commerce website to each of a plurality of merchants who are part of a federated e-commerce network, in accordance with various embodiments.

FIG. 5 is a general schematic flow diagram illustrating a method for generating targeted advertisement to a consumer based on the consumer's interactions with an e-commerce website, in accordance with various embodiments.

FIGS. 6A-6D are illustrations of mobile user devices used by users that present exemplary graphical user interfaces for providing a federated e-commerce website with which a consumer can interact, in accordance with various embodiments.

FIGS. 7A-7B are illustrations of mobile user devices used by users that present exemplary graphical user interfaces for providing a federated e-commerce website with which a merchant can interact, in accordance with various embodiments.

FIG. 8 is a block diagram illustrating an exemplary computer architecture, in accordance with various embodiments.

FIG. 9 is a block diagram illustrating a networked system of computers, which can be used in accordance with various embodiments.

### DETAILED DESCRIPTION OF CERTAIN EMBODIMENTS

While various aspects and features of certain embodiments have been summarized above, the following detailed description illustrates a few exemplary embodiments in further detail to enable one of skill in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art, however, that other embodiments of the present invention may be practiced without some of these specific details. In other instances, certain structures and devices are shown in block diagram form. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features.

Unless otherwise indicated, all numbers used herein to express quantities, dimensions, and so forth used should be understood as being modified in all instances by the term “about.” In this application, the use of the singular includes the plural unless specifically stated otherwise, and use of the terms “and” and “or” means “and/or” unless otherwise indicated. Moreover, the use of the term “including,” as well as other forms, such as “includes” and “included,” should be considered non-exclusive. Also, terms such as “element” or “component” encompass both elements and components comprising one unit and elements and components that comprise more than one unit, unless specifically stated otherwise.

Various embodiments provide techniques for providing and operating a federated e-commerce network. In some instances, a standard database is provided for local providers, stores, or retailers to automatically reflect their supply levels and prices in order to facilitate providing a national-level or international-level-type e-commerce experience for the local providers, stores, or retailers.

A system might also be provided that enables local business owners to be part of an Amazon.com-like Internet sales system by having local service providers (such as CenturyLink or the like) offer a small business cataloging interface so that Amazon.com or similar companies can federate the brick and mortar store inventory for another sales channel, and let the local business owners choose where and what they wish to sell. In a set of models, local service providers (e.g., CenturyLink or the like) might also provide a local sales search engine and “home market”-based small business service help and training over layer 1 and/or 2 of the Open Systems Interconnection (“OSI”) framework architecture. In some cases, the local service providers can maintain and operate the federated e-commerce online store on behalf of local retailers, as a subscription service or the like. Alternatively, the local service providers can set up the network components and system for the local retailers, with the federated e-commerce online store being maintained and operated by the local retailers as a collective or cooperative, or by a third party (separate from the local service providers who set up the network components and system) who are engaged by the local retailers.

The system is essentially an outsourcing of the internet sales channel by both the small business, and large sales organizations like Amazon.com via a federated universal sales and advertising database channel. None of this exists to date. In some cases, one could even couple this federated universal sales and advertising database channel system with delivery services such as the US postal service and outsource delivery as well, all in an automated fashion. Likewise, the federated universal sales and advertising database channel system can be coupled with banking networks, or other suitable payment networks, as well as with other e-commerce networks.

To create a local collaborative entity network that allows the automatic interfacing as a standard for any and all retailers to join banking and/or e-commerce networks, to provide an extremely local and “in real time” sales channel for local stores, a virtual private network (“VPN”) or VPN-like secure network might be created with registered end points like an automated teller machine (“ATM”) network that operates today with registered and secure interface devices for deployment at retail locations. A hybrid and/or dynamic state database might also be created for pushing, pulling, or forcing data levels to be polled and stored as changes occur in retailer stock levels.

In some instances, a common retailer inventory system might be established at each local retailer's location(s). Alternatively, for retailers having different inventory systems or solutions, an inventory interface components and/or supplemental merchandise tracking systems (“interfacing retailer inventory system”) may be implemented to provide a common basis for tracking inventory at each local retailer's location(s). An application programming interface (“API”) might be created between the common retailer inventory system or the interfacing retailer inventory system and the overall e-commerce federation. With communication links to the banks or other payment networks, customers may be provided with payment options, while the retailers may be provided with hold-type functionality, which might be based on policies of the bank, a credit card entity, or other payment entities (e.g., online payment entity such as PayPal, Inc., etc.).

In some examples, the system might be interfaced to an intelligent front end for searching the local stores and identifying customer “wants” in order to place ads for those customer's typical buying and/or viewing patterns. In some cases, the customers may be allowed to have a search portal with “wish lists,” “hate lists,” “gift lists,” and other options that might allow enhanced buy/sell experience for all parties.

In some cases, the information between the local VPN provider and the large e-commerce organization (e.g., Amazon.com) may be federated with revenue sharing based on a number of conditions including, without limitation, click-throughs, sales, and ad plays to customers. Real-time controls and portals may also be established and provided for retailers to control their “sales” to help move and/or push sales demand.

Herein, “network interface device” or “NID” might refer to a gateway device that connects the interior or internal data network within the customer premises with the exterior or external data network outside the customer premises (i.e., the network owned and/or operated by a service provider). The term “federated e-commerce network” (unless otherwise clear from context) might refer to a network of merchants or retailers, while “federated e-commerce network system” might refer to a system comprising hardware (including, without limitation, computer network equipment, telecommunications systems, servers, computers, databases, user devices, NIDs, etc.) and appropriate software applications. Herein also, the term “network” in the context of hardware might refer to a data or telecommunications network, while “network” in the context of e-commerce parties (e.g., merchant, retailer, customer, banks, charge card entities, or the like) might refer to a collective of such parties or entities.

The term “gateway function” or “gateway functions” might refer to any functions that allow database synchronization between a customer database and a federated database, via, e.g., electronic bonding or e-bonding for automated updates, manual entries that do not involve the merchant database, or the like. The gateway function(s) may exist at the federated e-commerce server, at one or more of the e-commerce NIDs, or both, and the gateway function(s) might perform information exchange and audits on the information being exchanged in order to “accept” inventory, or to stage the information exchange for auditing and correction. The system might use a standard information exchange model, which might be regulated by updating the gateway functions to use the exact same information model, and might audit functions once an information exchange has taken place, prior to the information being input into the other system.

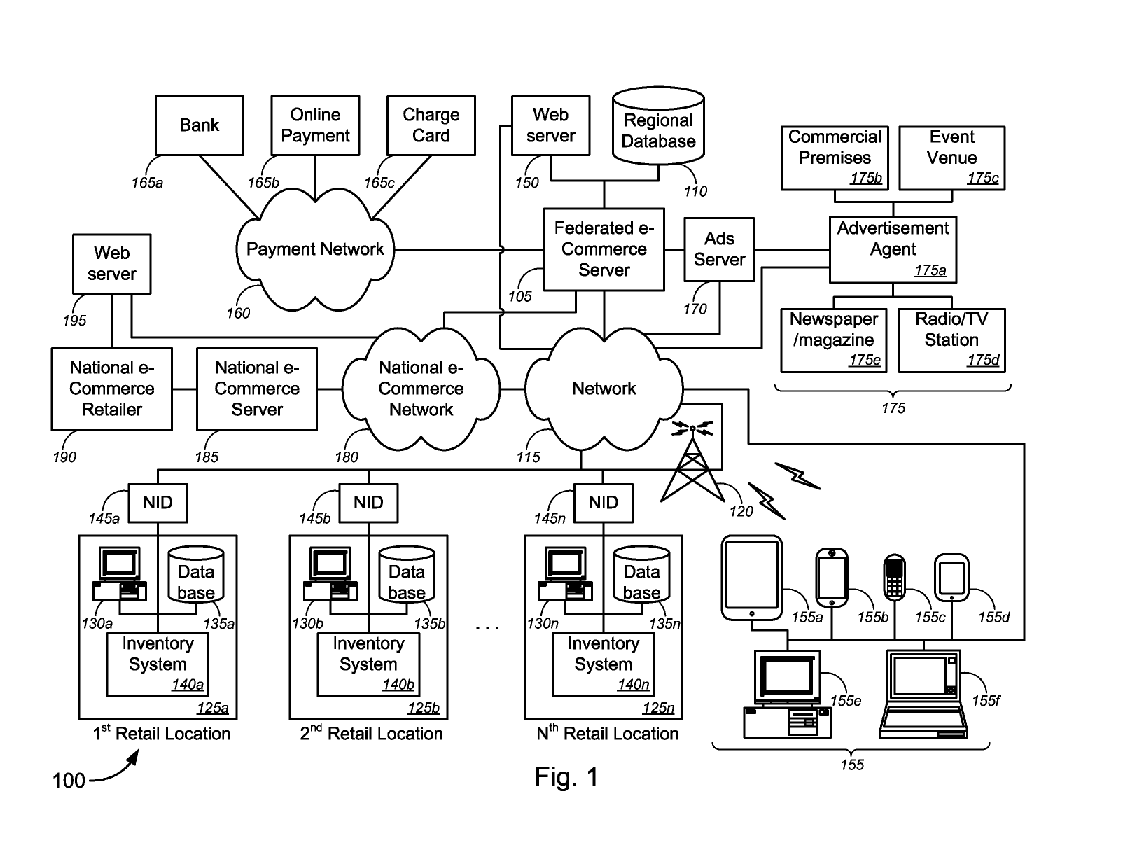

We now turn to the embodiments as illustrated by the drawings. FIGS. 1-9 illustrate some of the features of the method, system, and apparatus for providing and operating an e-commerce federated network, as referred to above. The methods, systems, and apparatuses illustrated by FIGS. 1-9 refer to examples of different embodiments that include various components and steps, which can be considered alternatives or which can be used in conjunction with one another in the various embodiments. The description of the illustrated methods, systems, and apparatuses shown in FIGS. 1-9 is provided for purposes of illustration and should not be considered to limit the scope of the different embodiments.

With reference to the figures, FIG. 1 is a general schematic diagram illustrating a system 100 for providing and operating a federated e-commerce network, in accordance with various embodiments. System 100, as shown in FIG. 1, might comprise a federated e-commerce server 105, a regional database 110, network 115, telecommunications relay systems 120, and a plurality of retail locations 125. The telecommunications relay systems 120 might include, without limitation, one or more wireless network interfaces (e.g., wireless modems, wireless access points, and the like), one or more towers, and/or one or more satellites, and the like.

The plurality of retail locations 125 might comprise a first retail location 125a, a second retail location 125b, through an N^{th} retail location 125n. Each retail location 125 might comprise a merchant computer 130, a merchant database 135, and an inventory system 140. For example, the first retail location 125a might comprise a merchant computer 130a, a merchant database 135a, and an inventory system 140a, while the second retail location 125b might comprise a merchant computer 130b, a merchant database 135b, and an inventory system 140b, and so on. Each merchant database 135a-135n might have stored thereon inventory information obtained from the corresponding inventory system 140a-140n, and might also have stored thereon local pricing information for each item of merchandise listed in the inventory of the subject retail location 125a-125n.

Each retail location 125 might be communicatively coupled to network 115 via a plurality of e-commerce network interface devices (“NIDs”), and in some cases, also via telecommunications relay systems 120. The plurality of e-commerce NIDs might comprise a first e-commerce NID 145a, a second e-commerce NID 145b, through an N^{th} e-commerce NID. The first e-commerce NID 145a might serve to communicatively couple the first retail location 125a to the network 115 (either directly or via telecommunications relay systems 120), while the second e-commerce NID 145b might serve to similarly communicatively couple the second retail location 125b to the network 115, and so on. System 100 might also comprise web server 150 communicatively coupled to one or more of the federated e-commerce server 105, regional database 110, and/or network 115. Web server 150 is configured to establish, operate, and/or maintain a federated e-commerce website that allows a user (e.g., a customer or potential customer) to search for and purchase merchandise items listed in a consolidated inventory list that compiles the inventory from each of inventory systems 140a-140n and/or from each of merchant databases 135a-135n. In some instances, web server 150 and federated e-commerce server 105 might be embodied as a single server or single cluster of servers. In other embodiments, web server 150 might be separate from federated e-commerce server 105, either physically (e.g., in the same site, but not physically mounted to each other, etc.), geographically (e.g., in two separate geographic locations, etc.), and/or functionally (e.g., using separate operating systems, etc.).

System 100 might further comprise one or more user devices 155 associated with one or more users or customers, the one or more user devices 155 being in communication with network 115 (in some cases, via telecommunications relay systems 120). Each of the one or more user devices 155 might be any suitable device including, but not limited to, a tablet computer 155a, a smart phone 155b, a mobile phone 155c, a personal digital assistant (“PDA”) 155d, a desktop computer 155e, or a laptop computer 155f, and the like.

System 100 might further comprise one or more payment networks 160, which might be communicatively coupled to one or more payment entities 165, which might include one or more banks 165a (or bank servers), one or more online payment entities 165b (or their servers), and/or one or more charge card entities 165c (or their servers). System 100 might also comprise an advertisement (or “ads”) server 170, which might be part of, or separate from, federated e-commerce server 105. The ads server 170 might communicate with one or more advertisement entities 175, either directly, or over a network (including network 115 or some similar network). The one or more advertisement entities 175 might comprise advertisement agent 175a, one or more commercial premises 175b, one or more event venues 175c, one or more radio or television stations 175d, and/or one or more newspapers or magazines 175e. In some cases, the ads server 170 might communicate directly with the one or more advertisement entities 175b-175e, or indirectly with the one or more advertisement entities 175b-175e via advertisement agent 175a. In any case, the ads server 170 and/or the advertisement agent 175a might send requests or advertisement orders for one or more merchandise items to the one or more commercial premises 175b (or their servers/computers), the one or more event venues 175c (or their servers/computers), the one or more newspapers or magazines 175e (or their servers/computers), and/or the one or more radio or television stations 175d (or their servers/computers). For example, commercial premises 175b might be a department store having monitors or advertising display panels set up in each department. In the case that the first merchant at the first retail location 125a is a hardware store desiring to advertise in a department store's hardware section and/or furniture section, the first merchant might, through the federated e-commerce server 105 and/or the ads server 170, purchase ads for display on the monitors or advertising display panels set up in the hardware section and/or furniture section for all or a selected group of merchandise listed in the inventory system 140a and/or merchant database 135a. In a similar manner, the first merchant might purchase ads for display at an event venue 175c (e.g., display screens at a local professional sports arena or stadium, concert hall, auditorium, etc.), announcement/broadcast by one or more radio stations and/or one or more television/cable stations 175d, and/or publication by one or more newspaper publishers and/or one or more magazine publishers 175e (either in printed publications and/or on the newspapers' and/or magazines' websites, etc.).

In some embodiments, system 100 might further comprise one or more national e-commerce networks 180, over which the federated e-commerce server 105 might be in communication with one or more national e-commerce servers 185, one or more national (or international) e-commerce retailers 190, and/or one or more web servers 195 associated with the one or more national (or international) e-commerce retailers 190.

The federated e-commerce server 105 might serve to compile, consolidate, or otherwise federate two or more local merchants, who might each own and/or operate one or more retail locations (such as the plurality of retail locations 125). In some instances, the local merchants might not individually have the resources or technical skills to establish (and/or maintain) their own e-commerce website. Such local merchants might thus benefit from a federated e-commerce network or network system, which might operate as a cooperative or might be operated by a service provider. Regional database 110 might compile and store inventory information from each merchant database 135, which might be updated, either on occasion, as part of a periodic update, or in response to preset conditions (including, but not limited to, each sales transaction, each restocking event, end of business day tally, end of week tally, end of month tally, end of quarter tally, end of fiscal year tally, etc.), based on information obtained from inventory system 140. Regional database 110 might be updated as each merchant database 135 is updated or might be updated based on a periodic update cycle, or in response to predetermined conditions (including, without limitation, each sales transaction, end of business day tally, end of week tally, end of month tally, end of quarter tally, end of fiscal year tally, etc. for each merchant database, or the like).

In some embodiments, the federated e-commerce server 105 and/or one or more of the first through N^{th} e-commerce NIDs 125a-125n might perform one or more gateway functions that provide data transfer between the regional database 110 and one or more of the merchant databases 135a-135n. The one or more gateway functions might comprise one or more of synchronizing data between the regional database 110 and one or more of the merchant databases 135a-135n, translating a local retailer inventory system 140 of one or more of the merchant computers 130a-130n into inventory objects at one or more of the federated e-commerce server 105 or the regional database 110, accepting manual input of inventory items by one or more of the first through N^{th} merchant, performing logical rules checks on the data prior to data transfer, facilitating handling of audit rejections by one or more of the first through N^{th} merchant, providing a question and answer portal to allow exchange of information regarding inventory, or providing access to a shared sales database located in the federated e-commerce network 115, wherein the shared sales database is one of the regional database 110 or a database separate from the regional database 110.

According to some embodiments, automatic updating of the regional database 110 might be performed in response to inventory updates being performed by at least one of the merchant databases 135a-135n. The federated e-commerce server 105 might determine whether inventory of a retail location 125a-125n has changed, e.g., based on analysis of at least one of sales transactions, merchandise tracking system data, business accounts, or merchandise stocking manifests of the subject retail location. In response to a determination that inventory of a retail location 125a-125n has changed, the federated e-commerce server 105 might poll the corresponding retail inventory system (i.e., the corresponding one of inventory systems 140a-140n). Based on results of the polling, the federated e-commerce server 105 might store the inventory changes of the subject retail location in the regional database 110.

One embodiment allows local store owners to add hash tagging to items to identify them as specialty items pertinent to specific bodies of interest that may be provided as a result of search queries in the federated database. The hash tag allows products to be grouped into a search query, and the text behind the hash tag informs the searcher as to how that product is useful for that specialty area. This could be locally relevant terminology, or simply a product that is used outside of its normal area of use.

The federated e-commerce server 105 and/or web server 150 might establish and/or maintain a website that integrates inventory information stored in the merchant databases 135a-135n, and might provide a consumer having access to the website (e.g., via one or more user devices 155) with tools to search consolidated inventory information corresponding to the inventory information stored in the merchant databases 135a-135n, which might also be stored in regional database 110. The federated e-commerce server 105 and/or web server 150 might provide the consumer with tools to purchase, via the website, one or more merchandise items listed in the consolidated inventory information stored in the regional database 110. The federated e-commerce server 105 and/or web server 150 might also update each of the regional database 110 and any affected merchant databases 135a-135n, based on the purchase of the one or more merchandise items via the website. As part of the purchase process, the federated e-commerce server 105 and/or web server 150 might provide communication between the federated e-commerce server 105 and one or more payment networks 160, and might provide the consumer (e.g., via one or more user devices 155 and via the website) with payment options (including, but not limited to, payment through the one or more banks 165a, the one or more online payment entities 165b, or the one or more charge card entities 165c) associated with the one or more payment networks 160 during purchasing of the one or more merchandise items.

In some instances, the federated e-commerce server 105 and/or web server 150 might provide retailer control to each of the merchants associated with retail locations 125a-125n via the federated e-commerce network 115. Herein, “retailer control” might refer to any type of control held by the retailer including, but not limited to, changing a sales status of each of the one or more merchandise items listed in the inventory information to indicate whether said each of the one or more merchandise items is a sale item that is available for sale on the website, changing a sale price for each sale item on the website, and/or changing a promotion status of each sale item to indicate whether said each sale item is to be advertised as being one of a discounted item, a clearance item, a best value item, or a featured item, or the like.

According to some embodiments, the federated e-commerce server 105 and/or the ads server 170 might generate advertisements based on at least one of the sales status, the sale price, or promotion status of each sale item, and might distribute the generated advertisements along one or more advertising channels (or to one or more advertisement entities 175) based on geographic location of each retail location 125 associated with each sale item. The one or more advertising channels might include at least one of television advertisement, advertisement associated with delivery of one or more on-demand content, Internet advertisement, e-mail advertisement, text message advertisement, smart-phone application advertisement, tablet computer application advertisement, online newspaper or magazine advertisement, electronic billboard advertisement, radio advertisement, online group advertisement, live sports event electronic advertisement, or in-store electronic advertisement.

Alternatively, or in addition, the federated e-commerce server 105 and/or the ads server 170 might identify customer pattern information associated with each customer, based on buying and viewing patterns of each customer on the website. Such patterns might be stored in a database (such as regional database 110, or similar database). The federated e-commerce server 105 and/or the ads server 170 might provide each customer with options to create, modify, or delete at least one of one or more wish lists, one or more hate lists, or one or more gift lists. The federated e-commerce server 105 and/or the ads server 170 might also generate targeted advertisement for each customer, based on at least one of the customer pattern information, the one or more wish lists, the one or more hate lists, or the one or more gift lists associated with each customer.

In some embodiments, the federated e-commerce server 105 might provide communication between the federated e-commerce server 105 and one or more national or international e-commerce servers 185 associated with one or more national or international e-commerce retailers 190 via one or more national or international e-commerce networks 180. Each of the one or more national or international e-commerce servers might be configured to establish or maintain a national or international e-commerce website 195. The federated e-commerce server 105 might send the consolidated inventory information stored in the regional database 110 to the one or more national or international e-commerce servers 185 for presentation and searching, on the national or international e-commerce website 195, of the one or more merchandise items listed in the consolidated inventory information.

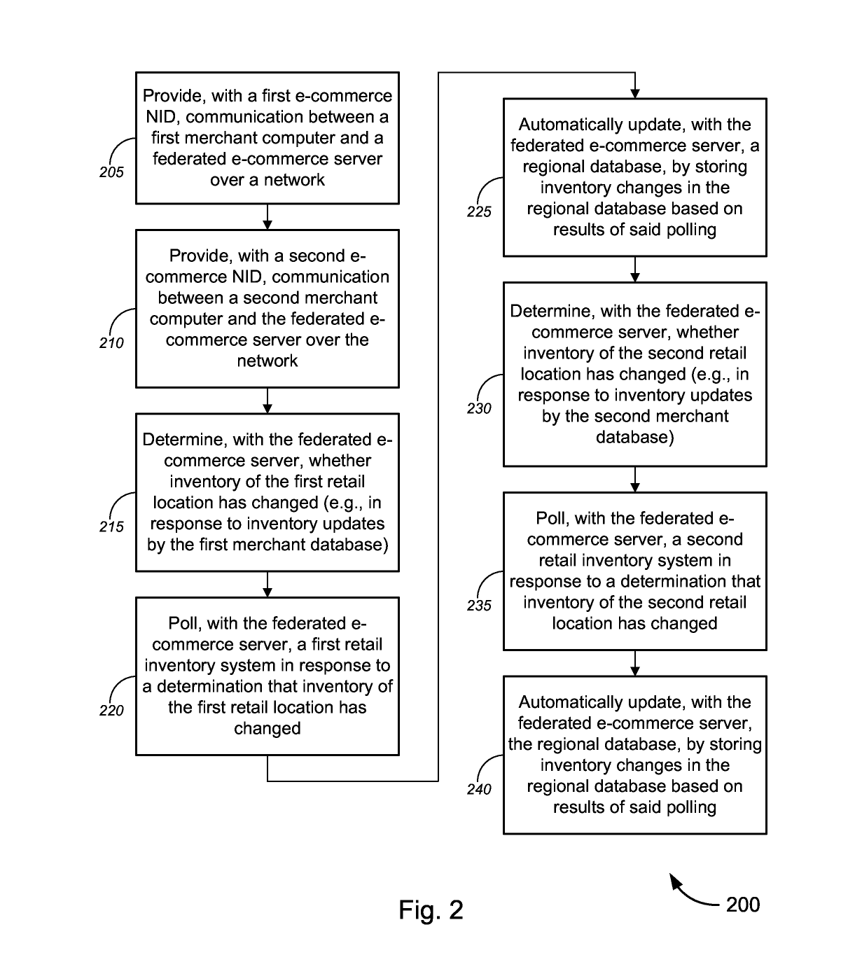

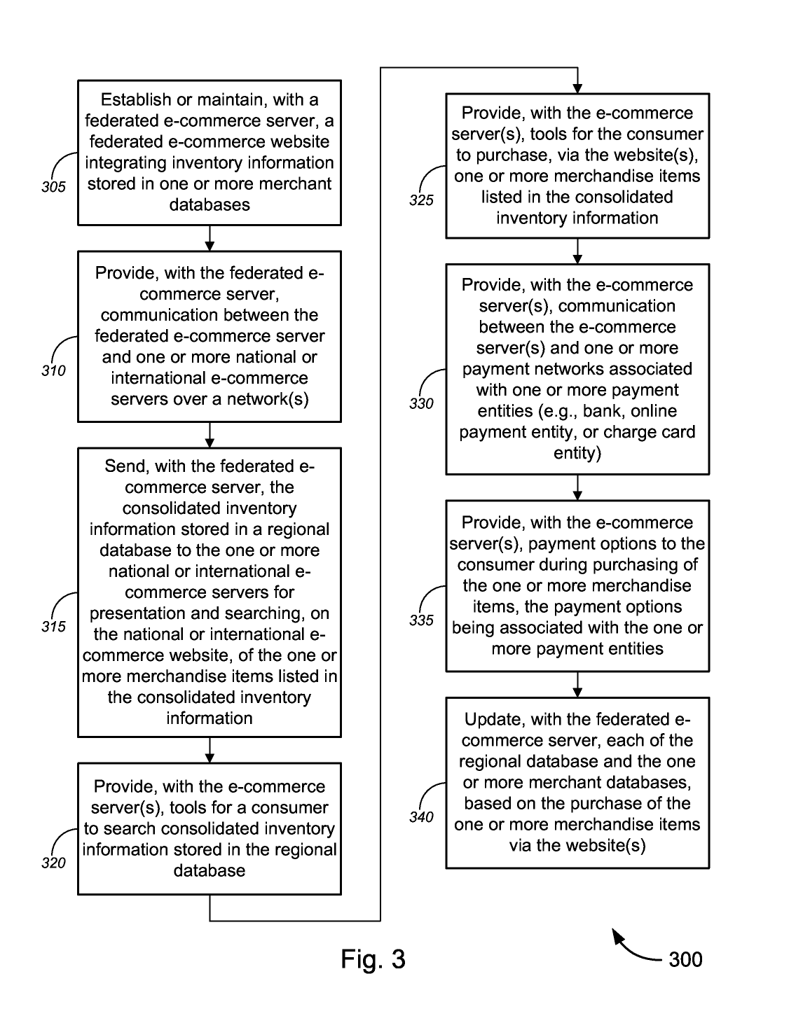

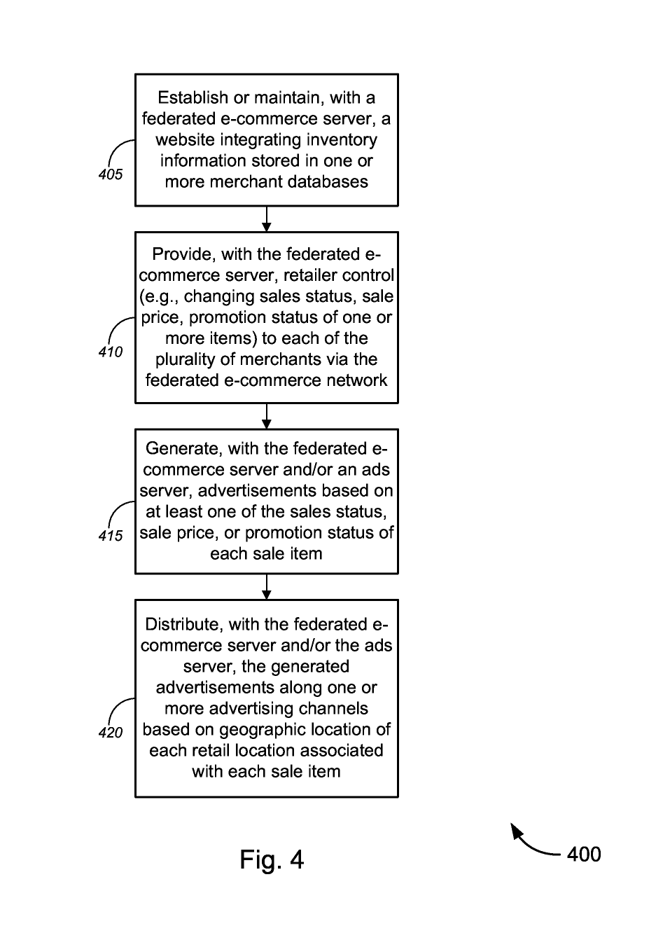

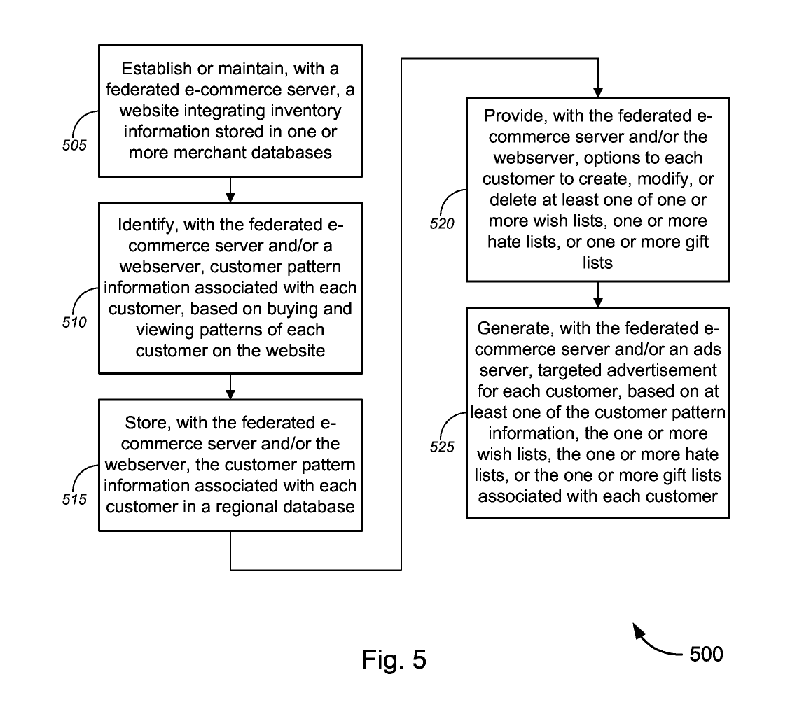

We now turn to FIGS. 2-5, which illustrate flow charts of various processes related to providing and operating a federated e-commerce network, according to various embodiments. In particular, FIG. 2 is a general schematic flow diagram illustrating a method 200 for implementing automatic updates of a regional database based on inventory updates of local retail databases using a federated e-commerce network system, in accordance with various embodiments. FIG. 3 is a general schematic flow diagram illustrating a method 300 for implementing an e-commerce website with which a consumer can interact to search for and purchase merchandise items across local retailer inventories within a federated e-commerce network system, in accordance with various embodiments. FIG. 4 is a general schematic flow diagram illustrating a method 400 for providing retailer control over an e-commerce website to each of a plurality of merchants who are part of a federated e-commerce network, in accordance with various embodiments. FIG. 5 is a general schematic flow diagram illustrating a method 500 for generating targeted advertisement to a consumer based on the consumer's interactions with an e-commerce website, in accordance with various embodiments.

In FIG. 2, method 200 might comprise providing, with a first e-commerce NID (such as first e-commerce NID 145a shown in FIG. 1), communication between a first merchant computer (e.g., merchant computer 130a shown in FIG. 1) and a federated e-commerce server (e.g., federated e-commerce server 105 shown in FIG. 1) over a network (including, but not limited to network 115 shown in FIG. 1) [block 205]. At block 210, method 200 might further comprise providing, with a second e-commerce NID (such as second e-commerce NID 145b shown in FIG. 1), communication between a second merchant computer (e.g., merchant computer 130b shown in FIG. 1) and the federated e-commerce server (e.g., federated e-commerce server 105) over the network (which might include network 115 or some similar network).

Method 200 might further comprise, at block 215, determining, with the federated e-commerce server, whether inventory of the first retail location (e.g., retail location 125a shown in FIG. 1) has changed. In some cases, such a determination may be made in response to inventory updates provided by the first merchant database (e.g., merchant database 135a shown in FIG. 1). The inventory updates may, in some instances, be sent automatically from the first merchant database to the federated e-commerce server either periodically (e.g., hourly, every few hours, at the close of business every day, every few days, every week, every other week, every month, etc.) or after a predetermined number of transactions (including, but not limited to, 1, 2, 3, 4, 5, 10, 12, 15, or 20 transactions, etc.). According to some embodiments, regardless of whether inventory updates are sent from the first merchant database to the federated e-commerce server, the federated e-commerce server might send a request for inventory updates from the first merchant database.

The method 200 might further comprise polling, with the federated e-commerce server, a first retail inventory system (e.g., inventory system 140a shown in FIG. 1) in response to a determination that inventory of the first retail location has changed (block 220). Although, in theory, the first merchant database should be up to date with the inventory list compiled by the first retail inventory system, the polling at block 220 ensures that the inventory list maintained and updated by the first retail inventory system matches the inventory list stored in the regional database for the first retail location as modified by the inventory updates received from the first merchant database (e.g., merchant database 135a). In some cases, rather than simply sending updates in the form of changes to the inventory list, the inventory updates might comprise a full (and current) inventory list of the inventory at the first retail location. According to some embodiments, the first retail inventory system might comprise one or more of a wireless tag (e.g., radio frequency identification (“RFID”) tag, or the like) communications and tracking system that sends signals to, and receives signals from, wireless tags (e.g., RFID tags, or the like) affixed to merchandise items, or a bar code scanner for reading bar codes on packages of sold merchandise items, or other suitable merchandise tracking system, or the like. The wireless tag communications and tracking system might be located at each entrance/exit of a store of the first retail location, at each entrance/exit of a warehouse portion of the first retail location, and/or at each checkout register at the first retail location. The bar code scanner might be tied to specific locations at the first retail location (e.g., at one or more shelves in the store front, at one or more shelves in the warehouse, at each checkout register, etc.), or may be portable for mobile use by employees at the first retail location. In some embodiments, the wireless tag communications and tracking system and/or the bar code scanner might be integrated within a mobile user device (e.g., smart phone, tablet computer, customized retail merchandise tracking unit, etc.) that may be provided to one or more employees for mobile use in connection with the retail location.

In the case that there is a discrepancy between the information provided by the inventory updates from the first merchant database and the first retail inventory system, the inventory list from the first retail inventory system would supersede the inventory updates from the first merchant database. This is because the first retail inventory system is intended to track the actual location of particular merchandise items (e.g., by determining whether or not the particular merchandise items have left the retail location or are one specific shelves or regions of the retail location, etc.), whereas the merchant database might only receive updates from the retail inventory system and/or track sales transactions, business accounts, merchandise stocking manifests, etc. that might in some cases be at least partially updated manually (and perhaps subject to user error in data entry, or the like). In the case that all sales transactions, business accounts, and merchandise stocking manifests are automated and continually updated and synchronized with the merchant database, the inventory updates sent by the first merchant database should track more precisely with the inventory lists maintained and updated by the first retail inventory system.

At block 225, method 200 might further comprise automatically updating, with the federated e-commerce server, a regional database (e.g., regional database 110 shown in FIG. 1), by storing inventory changes in the regional database based on results of the polling of the first retail inventory system at block 220.

The process at blocks 230 through 240 are similar, if not identical to the process at blocks 215 through 225, except that inventory and inventory changes are tracked at the second retail location rather than at the first retail location, and the regional database is automatically updated with any changes in inventory at the second retail location. As such, the processes and various alternative embodiments described above with respect to the tracking inventory and inventory changes at the first retail location and updating any inventory changes at the regional database are applicable to the processes in blocks 230 through 240.

With reference to FIG. 3, method 300 might comprise establishing or maintaining, with a federated e-commerce server (e.g., federated e-commerce server 105), a federated e-commerce website integrating inventory information stored in one or more merchant databases (e.g., merchant databases 135a through 135n) [block 305]. At block 310, method 300 might comprise providing, with the federated e-commerce server, communication between the federated e-commerce server and one or more national or international e-commerce servers (e.g., one or more national or international e-commerce servers 185 shown in FIG. 1) over one or more networks (e.g., one or more national or international e-commerce networks 180 shown in FIG. 1). Method 300 might further comprise, at block 315, sending, with the federated e-commerce server, the consolidated inventory information (including, e.g., inventory information of two or more retail locations within the federated e-commerce network) stored in a regional database (e.g., regional database 110) to the one or more national or international e-commerce servers. By sending the consolidated inventory information to the one or more national or international e-commerce servers, one or more merchandise items listed in the consolidated inventory information may thus be presented and searched on a national or international e-commerce website (e.g., national or international e-commerce website 195 shown in FIG. 1) associated with the one or more national or international e-commerce servers.

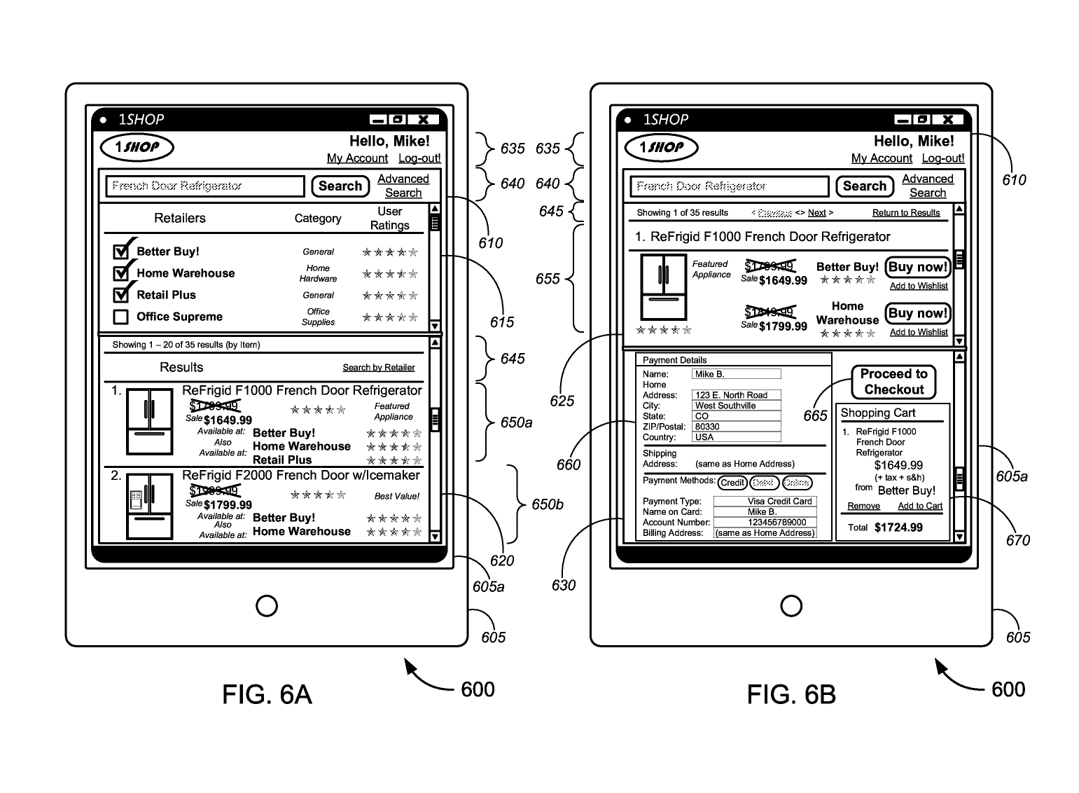

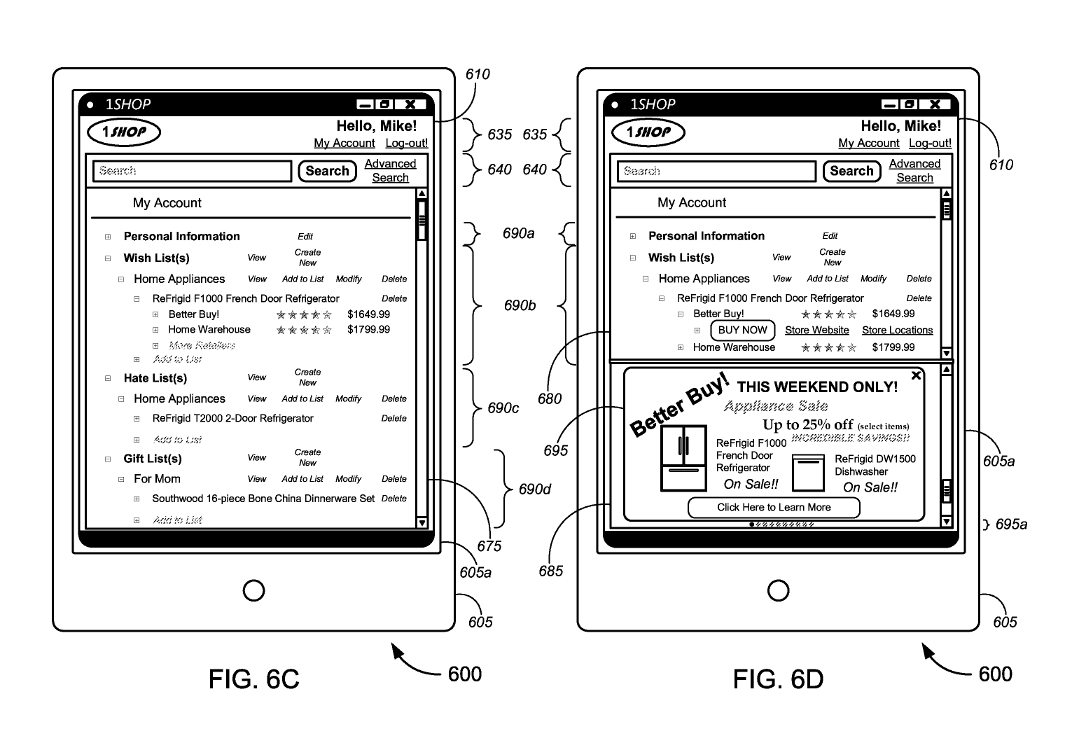

At block 320, method 300 might comprise providing—with the federated e-commerce server, the one or more national or international e-commerce servers, and/or a webserver (e.g., webserver 150 and/or webserver 195 shown in FIG. 1)—tools for a consumer to search the consolidated inventory information stored in the regional database. Method 300 might further comprise, at block 325, providing—with the federated e-commerce server, the one or more national or international e-commerce servers, and/or the webserver—tools for the consumer to purchase, via the federated e-commerce website and/or the national or international e-commerce website, one or more merchandise items listed in the consolidated inventory information. At block 330, method 300 might further comprise providing—with the federated e-commerce server, the one or more national or international e-commerce servers, and/or the webserver—communication between the federated e-commerce server (and/or the one or more national or international e-commerce servers) and one or more payment networks (e.g., one or more payment networks 160 shown in FIG. 1), which might be associated with one or more payment entities (e.g., one or more banks 165a, one or more online payment entities 165b, or one or more charge card entities 165c shown in FIG. 1, or the like). Method 300 might comprise providing—with the federated e-commerce server, the one or more national or international e-commerce servers, and/or the webservers—payment options to the consumer during purchasing of the one or more merchandise items (block 335). The payment options might be associated with the one or more payment entities. An example of such an implementation is shown and described, e.g., with respect to FIG. 6B below.

The method 300, at block 340, might comprise updating, with the federated e-commerce server, each of the regional database and the one or more merchant databases, based on the purchase of the one or more merchandise items via the federated e-commerce website and/or the national or international e-commerce website.

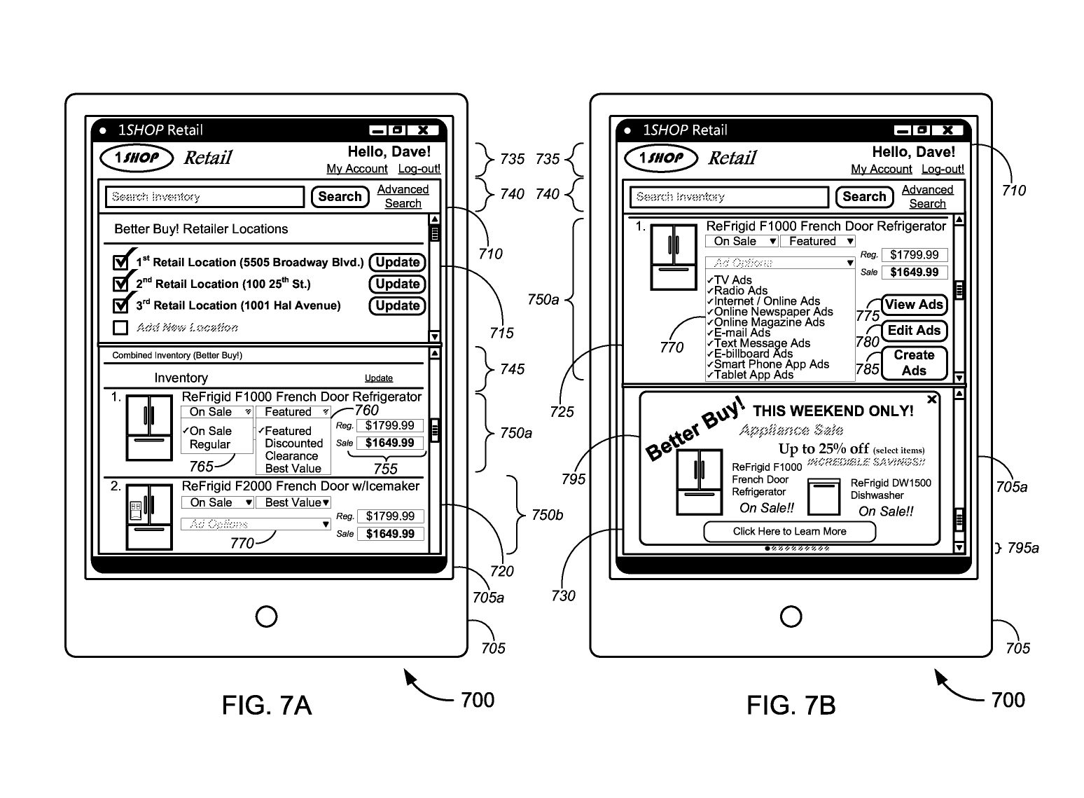

Turning to FIG. 4, method 400 might comprise, at block 405, establishing or maintaining, with a federated e-commerce server (e.g., federated e-commerce server 105), a website integrating inventory information stored in one or more merchant databases (e.g., merchant databases 135a-135n). At block 410, method 400 might comprise providing, with the federated e-commerce server, retailer control to each of the plurality of merchants via the federated e-commerce network system. As above, “retailer control” might refer to any type of control held by the retailer including, but not limited to, changing a sales status of each of the one or more merchandise items listed in the inventory information to indicate whether said each of the one or more merchandise items is a sale item that is available for sale on the website (and/or in store), changing a sale price for each sale item on the website, and/or changing a promotion status of each sale item to indicate whether said each sale item is to be advertised as being one of a discounted item, a clearance item, a best value item, or a featured item, or the like. An example of such an implementation is shown and described, e.g., with respect to FIGS. 7A and 7B below.

Method 400 might further comprise generating, with the federated e-commerce server and/or an ads server (e.g., ads server 170 shown in FIG. 1), advertisements based on at least one of the sales status, sale price, or promotion status of each sale item (block 415). An example of such an implementation is shown and described, e.g., with respect to FIG. 7B below. At block 420, method 400 might comprise distributing, with the federated e-commerce server and/or the ads server, the generated advertisements along one or more advertising channels (associated with one or more advertising entities), based on geographic location of each retail location associated with each sale item.

In FIG. 5, method 500 might comprise, at block 505, establishing or maintaining, with a federated e-commerce server (e.g., federated e-commerce server 105), a website integrating inventory information stored in one or more merchant databases (e.g., merchant databases 135a-135n). At block 510, method 500 might comprise identifying, with the federated e-commerce server and/or a webserver (e.g., webserver 150), customer pattern information associated with each customer, based on buying and viewing patterns of each customer on the website. Method 500 might further comprise storing, with the federated e-commerce server and/or the webserver, the customer pattern information associated with each customer in a regional database (e.g., regional database 110) [block 515].

At block 520, method 500 might comprise providing, with the federated e-commerce server and/or the webserver, options to each customer to create, modify, or delete at least one of one or more wish lists, one or more hate lists, or one or more gift lists. An example of such an implementation is shown and described, e.g., with respect to FIG. 6C below.

Method 500 might further comprise, at block 525, generating, with the federated e-commerce server and/or an ads server, targeted advertisement for each customer, based on at least one of the customer pattern information, the one or more wish lists, the one or more hate lists, or the one or more gift lists associated with each customer. An example of such an implementation is shown and described, e.g., with respect to FIG. 6D below.

FIGS. 6A-6D (collectively, “FIG. 6”) are illustrations of mobile user devices 600 used by users that present exemplary graphical user interfaces 610 for providing a federated e-commerce website with which a consumer can interact, in accordance with various embodiments. For purposes of illustration only, user device 600 in FIG. 6 is shown as a tablet computer, but can be any user computer or user device including, but not limited to, a desktop or PC, a laptop computer, a tablet computer, a smart phone, a mobile phone, or the like—such as tablet computer 155a, smart phone 155b, mobile phone 155c, PDA 155d, desktop computer 155e, or laptop computer 155f, as shown in FIG. 1. User device 600 might comprise device housing 605, display screen 605a, and the like. Display screen 605a might comprise a touchscreen display, a non-touchscreen display, or the like. Displayed on the display screen 605a might be a graphical user interface (“GUI”) 610, which may be a free floating GUI window filling a portion of the display screen 605a or may be a software application that fills the entire display screen 605a. In some cases, the GUI 610 might comprise a window that might be divided into two or more panels 615, 620, 625, 630, 675, 680, and 685, e.g., by using a split screen arrangement or a separate window arrangement (which might stack or tile the separate windows). Alternatively, the two or more panels 615, 620, 625, 630, 675, 680, and 685 might be independent windows or related but separate windows.

In FIG. 6A, the user device 600 might perform one, more, or all of the processes described above for providing and operating a federated e-commerce network. Alternatively, or additionally, a server (such as federated e-commerce server 105, webserver 150, national or international server 185, and/or webserver 195, or the like) might perform one, more, or all of the processes described above for providing and operating a federated e-commerce network. In some examples, GUI 610 might comprise a header portion 635, which might include a logo for the federated e-commerce website (in this case, “1SHOP”), a welcome notice for the consumer (who in this example has logged into the website), a link for the consumer to edit profiles, options, or otherwise manage his or her account, and an option to log out of the website. GUI 610 might further comprise a search bar or search field 640, which might comprise an input search field, a search command button or link, and an option to access advanced search options (including, but not limited to, selecting manufacturers, model numbers, price ranges, user rating ranges, product categories, dates of product releases, type of product, features of product, etc.).

According to some embodiments, the GUI 610 might comprise a panel 615 that might display a list of local retailers or merchants, and, for each local retailer or merchant, might display a category generally describing the type of retailer or merchant (including, but not limited to, general, home hardware, office supplies, etc.). In some embodiments, user ratings for each retailer or merchant may also be displayed. Although FIG. 6 shows user ratings in the form of a five-pointed star, with white or unshaded stars each indicating “0,” each of the five points of a star indicating “0.2,” half of one of the five points of a star indicating “0.1,” and gray or fully shaded stars each indicating “1.0,” the various embodiments are not so limited, and any suitable indication of user ratings (including, but not limited, to pie charts, any polygon, any irregular shaped object, or the like, each replacing a five-pointed star). Additionally, or alternatively, a numerical rating might be used; for example, in the case of retailer “Home Warehouse” in FIG. 6A, a numerical rating would include the numerals “3.5” for the 3 and one half shaded stars. In some cases, the numerical rating might include percentages (e.g., an average of how satisfied the users might be, based on input by the users, where 100% is extremely satisfied and 0% is extremely unsatisfied, or the like). Further, although a 5 point (or five star) system is shown in the examples of FIG. 6, any suitable system may be used—including, but not limited to a 3 point (or 3 star) system, a 4 point (or 4 star) system, a 10 point (or 10 star) system, or the like. In panel 615, each retailer that is listed might be displayed with a corresponding selector icon (including, without limitation, a check box, radial dial, square block selector, etc.), which when selected by the consumer selects one or more retailers, whose databases are desired to be searched by the consumer. In the example of FIG. 6A, retailers “Better Buy!,” “Home Warehouse,” and “Retail Plus” are selected by the consumer, while “Office Supreme” is not selected.

In the example of FIG. 6, the item being searched is a French door refrigerator. Upon initiating the search of a consolidated inventory list compiling the inventories and/or databases of “Better Buy!,” “Home Warehouse,” and “Retail Plus,” search results may be displayed in panel 620. In panel 620, a search summary portion 645 might be displayed, and might indicate the number of total results, the number of results currently shown in the panel, and how the results are being sorted or presented (e.g., by item, by retailer, or the like). In the example of FIG. 6A, 35 results might be returned for “French Door Refrigerator,” with 20 results showing within the scrollable panel. In this example, the results are organized by item. The order of the results listed by item might be alphabetical, based on user ratings, based on price, or based on promotional status (e.g., on sale, featured, best value, discounted, etc.). For each result, a photograph or diagram of the item or product may be displayed, along with the manufacturer, name, and model number, a regular price, a sale price (if any), a user rating (similar to the retailer user rating discussed above), an indication of promotional status, and/or availability of the item at one or more of the retailers selected in panel 615, or the like. For example, as shown in FIG. 6A, a search of “French Door Refrigerator” from the three retailers listed above might return as the first result 650a (of multiple results 650), “Refrigid F1000 French Door Refrigerator,” which might be a three door refrigerator without an icemaker mounted in the door. In the example, the regular price of the F1000 might be $1799.99, with a sale price of “$1649.99, having an average user rating of 3.6 stars. The F1000 might be a featured appliance (perhaps because of its relatively low sale price), and might be available at “Better Buy!,” and also available at “Home Warehouse” and “Retail Plus.” The average user ratings for this model refrigerator at each of “Better Buy!,” “Home Warehouse,” and “Retail Plus” might, in some instances, be provided—in this example, 3.8, 3.6, and 3.4, respectively.

Alternatively, instead of organizing the results by item, the results may be organized by retailer, in which case the results would be sorted by grouping the results for each retailer. For example, all results from “Better Buy!” might be listed first, while all results from “Home Warehouse” might be listed second, and so on. The order of the retailers might be alphabetical or based on overall retailer user ratings. The order of the results for each retailer might be alphabetical, based on user ratings, based on price, or based on promotional status (e.g., on sale, featured, best value, discounted, etc.).

User selection (e.g., by double-clicking or touch tapping on the corresponding portion of display 605a, or the like) of the icon, name/model, or other portion of the result field 650 might bring the user to panel 625. For example, if ReFrigid F1000 in the first result field 650a was selected, an item field 655 in panel 625 might be displayed, as shown, e.g., in FIG. 6B. In item field 655, the name and model of the item, the photograph or diagram, the average user rating, and/or the promotional status of the item might be displayed. In some instances, the regular price and/or sale price of the item at each of the relevant retailers might be listed, together with options to “Buy now!” or “Add to Wishlist” with respect to the particular retailer. For example, if the consumer wishes to buy the ReFrigid F1000 refrigerator from “Better Buy!” at a sale price of $1649.99, the consumer can simply select the “Buy now!” button or link, which might lead the consumer to a purchase options panel 630, which might present a payment options region 660, in which the consumer might enter his or her name, home address, city, state, postal code, and country, indicate whether the shipping address is the same or different from the home address (and fill in the shipping address information, if different), and provide payment methods.

The payment methods might comprise, without limitation, credit, debit, and online payment options. For the credit method, the payment type might include, for example, Visa® Credit Card, MasterCard® Credit Card, American Express® Credit Card, Discover® Card, or the like. For the debit method, the payment type might include a debit card associated with a financial institution (e.g., bank, etc.). For the online method, the payment type might include PayPal® or other online payment entities. Payment options region 660 might further include the name of the credit card holder, debit card holder, or online payment account, an account or card number, billing address, and the like. Additional fields might prompt for the expiration date of a credit card and/or debit card, and in some cases, might prompt for a card security code (sometimes referred to as a card verification value (“CVV” or “CVV2”), card validation code (“CVC” or “CVC2”), card identification code (“CID”), card security code (“CSC”), or the like).

In some embodiments, panel 630 might include a “Proceed to Checkout” button or link 665, which might take the consumer to a verification and confirmation webpage, providing the consumer with an option to cancel the order or to place the order. In some instances, panel 630 might further comprise a summary field or shopping cart field 670, which might list the items in the consumer's shopping cart, the sale price, the retailer, the total price (i.e., sale price plus tax and/or shipping and handling fees (if any)). The shopping cart field might also present the consumer with options to remove the item from the shopping cart or to add other items to the cart.

With reference to FIGS. 6C-6D, when the consumer selects the “My Account” button or link, various user options 690 might be displayed, e.g., as shown in panel 675. The various user options 690, according to some embodiments, might include personal information 690a, wish list(s) 690b, hate list(s) 690c, and/or gift list(s) 690d. In general, the personal information concerns the consumer specifically, while the wish list indicates what the consumer would like to purchase, the hate list indicates what the consumer would not like to purchase, and the gift list indicates what the consumer would like to purchase for other people. In some instances, the gift list might indicate what the consumer would like others to purchase for him or her, and such gift list might be made available to said others either via e-mail, text message, or authorized access to the specific gift list (but not to other information associated with the customer).

Each of these user options 690 and sub-options might be selectably expanded or compressed. For example, the Personal Information option 690a is shown in the compressed state. Selection of the expansion icon to the left of the Personal Information option 690a or selection of the “Edit” option corresponding to option 690a might expand the field to allow the consumer to edit his or her personal information (including, but not limited to, contact information, payment option/method fields for auto-populating payment option/method fields when logged into the e-commerce website, user name, password, security questions and phrases, etc.). The wish list(s) field 690b, hate list(s) field 690c, and gift list(s) field 690d show examples of various levels of expansion of each field. In the first level, the options might include, without limitation, viewing the corresponding wish list(s), hate list(s), or gift list(s), and creating a new wish list(s), hate list(s), or gift list(s). At a second level, a user might create a list (e.g., “Home Appliances” for each of the wish list 690b and hate list 690c). At this second level, the options might include, but is not limited to, viewing the list, adding items to the list, modifying the list, or deleting the list. At a third level, each item in the list might be displayed, and might include an option to delete the subject item from the list. At a fourth level, one or more retailers might be listed, together with user ratings for the item at the corresponding retailer, as well as a sale price. At a fifth level (as shown in panel 680 in FIG. 6D), options might include “buying now” from the specific retailer, linking to a store website for the retailer, and/or linking to a page indicating the store locations (and/or store hours).

In panel 685 in FIG. 6D, ads 695 may be automatically generated (e.g., by the e-commerce server and/or ads server, or the like) and displayed based on, for example, at least one of the customer buying and/or viewing patterns, the one or more wish lists, the one or more hate lists, or the one or more gift lists associated with the customer. In the example of FIG. 6D, 10 ads might be generated at a time, with each ad being selectable by icons 695a. Otherwise, the panel 685 might cycle through display of each of the 10 ads 695 at predetermined durations each. Although 10 ads are described as being generated, any suitable number may be generated. In some cases, instead of cycling through the generated ads, some or all of the generated ads might be displayed in panel 685. The order of the ads might be based on level of relevance with the at least one of the customer buying and/or viewing patterns, the one or more wish lists, the one or more hate lists, or the one or more gift lists associated with the customer.

With reference to FIGS. 7A and 7B (collectively, “FIG. 7”)—which are illustrations of mobile user devices 700 used by users that present exemplary graphical user interfaces 710 for providing a federated e-commerce website with which a merchant can interact, in accordance with various embodiments—, a similar website and user interface as described above with respect to FIG. 6 might be provided for a retailer. As with FIG. 6, user device 700 in FIG. 7 is shown, for purposes of illustration only, as a tablet computer, but can be any user computer or user device including, but not limited to, a desktop or PC, a laptop computer, a tablet computer, a smart phone, a mobile phone, or the like—such as tablet computer 155a, smart phone 155b, mobile phone 155c, PDA 155d, desktop computer 155e, or laptop computer 155f, as shown in FIG. 1. User device 700 might comprise device housing 705, display screen 705a, and the like. Display screen 705a might comprise a touchscreen display, a non-touchscreen display, or the like. Displayed on the display screen 705a might be a graphical user interface (“GUI”) 710, which may be a free floating GUI window filling a portion of the display screen 705a or may be a software application that fills the entire display screen 705a. In some cases, the GUI 710 might comprise a window that might be divided into two or more panels 715, 720, 725, and 730, e.g., by using a split screen arrangement or a separate window arrangement (which might stack or tile the separate windows). Alternatively, the two or more panels 715, 720, 725, and 730 might be independent windows or related but separate windows.

In FIG. 7A, the user device 700 might perform one, more, or all of the processes described above for providing and operating a federated e-commerce network. Alternatively, or additionally, a server (such as federated e-commerce server 105, webserver 150, national or international server 185, and/or webserver 195, or the like) might perform one, more, or all of the processes described above for providing and operating a federated e-commerce network. In some examples, GUI 710 might comprise a header portion 735, which might include a logo for the federated e-commerce website (in this case, “1SHOP Retail”), a welcome notice for the retailer or employee of the retailer (who in this example has logged into the website), a link for the retailer or employee to edit profiles, options, or otherwise manage its account, and an option to log out of the website. GUI 710 might further comprise a search inventory field 740, which might comprise an input inventory search field, a search command button or link, and an option to access advanced search options (including, but not limited to, selecting manufacturers, model numbers, price ranges, user rating ranges, product categories, dates of product releases, type of product, features of product, quantity of items, length of time in inventory, etc.).

According to some embodiments, the GUI 710 might comprise a panel 715 that might display a list of retail locations owned and/or operated by the retailer, with options for the retailer to select one or more of these retail locations, to update information about each location, to update inventory of each location, or to add a new retail location. The retailer may search the combined inventory of the entire list of selected retail locations, or specific products or types of products in the combined inventory. Results of the search might be displayed in panel 720, which might include a results summary portion 745 and a plurality of result fields 750 (including a first result field 750a, a second result field 750b, and so on). In some cases, the results summary portion 745 might include an option to update the list of results. In each result field 750, a photograph or diagram of the item may be displayed, along with the manufacture, name, and/or model of the item. Also displayed in each result field 750 might be options for the retailer to input regular and sales prices 755, the promotional status 760 (including, without limitation, featured, discounted, clearance, and best value, or the like), the sales status 765 (including, but not limited to, on sale, regular price, etc.), and/or ad options 770 for the item. As shown in the example of FIG. 7B, ad options 770 might include, without limitation, television (“TV”) ads, radio ads, Internet or online ads, online newspaper ads, online magazine ads, e-mail ads, text message ads, electronic billboard (or e-billboard) ads, smart phone app ads, and/or table app ads, or the like. Other ad options might include options to view the ads 775, edit the ads 780, and create ads 785.

In panel 730 in FIG. 7B, ads 795 may be automatically generated (e.g., by the e-commerce server and/or ads server, or the like) and displayed based on, for example, at least one of the sales status, the sale price, the promotion status, and/or the ad options for each item. The view ads option 775 might allow the retailer to view the generated ads, while the edit ads option 780 might allow the retailer to edit the automatically generated ads. The create ads option 785 might allow the retailer to create its own ads in addition to or in place of the automatically generated ads.

In the example of FIG. 7B, 10 ads might be generated at a time, with each ad being selectable by icons 795a. Otherwise, the panel 730 might cycle through display of each of the 10 ads 695 at predetermined durations each. Although 10 ads are described as being generated, any suitable number may be generated. In some cases, instead of cycling through the generated ads, some or all of the generated ads might be displayed in panel 730. The order of the ads might be based on level of relevance with the at least one of the sales status, the sale price, the promotion status, and/or the ad options for each item.

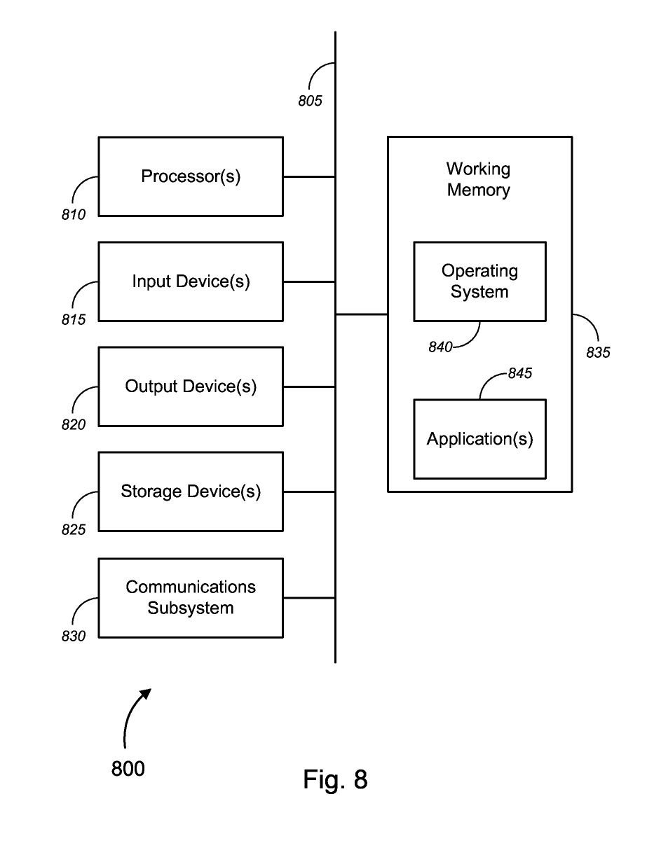

We now turn to FIG. 8, which is a block diagram illustrating an exemplary computer architecture. FIG. 8 provides a schematic illustration of one embodiment of a computer system 800 that can perform the methods provided by various other embodiments, as described herein, and/or can perform the functions of local computer system 130, remote computer system 105, 150, 170, 185, or 195, user computer system 155, or other computer systems as described above. It should be noted that FIG. 8 is meant only to provide a generalized illustration of various components, of which one or more, or none, of each may be utilized as appropriate. FIG. 8, therefore, broadly illustrates how individual system elements may be implemented in a relatively separated or relatively more integrated manner.

The computer system 800 is shown comprising hardware elements that can be electrically coupled via a bus 805, or may otherwise be in communication, as appropriate. The hardware elements may include one or more processors 810, including without limitation one or more general-purpose processors, or one or more special-purpose processors such as digital signal processing chips, graphics acceleration processors, or the like; one or more input devices 815, which can include without limitation a mouse, a keyboard, or the like; and one or more output devices 820, which can include without limitation a display device, a printer, or the like.

The computer system 800 may further include, or be in communication with, one or more storage devices 825. The one or more storage devices 825 can comprise, without limitation, local and/or network accessible storage, or can include, without limitation, a disk drive, a drive array, an optical storage device, a solid-state storage device. The solid-state storage device can include, but is not limited to, one or more of a random access memory (“RAM”) or a read-only memory (“ROM”), which can be programmable, flash-updateable, or the like. Such storage devices may be configured to implement any appropriate data stores, including without limitation various file systems, database structures, or the like.

The computer system 800 might also include a communications subsystem 830, which can include without limitation a modem, a network card (wireless or wired), an infra-red communication device, a wireless communication device or chipset, or the like. The wireless communication device might include, but is not limited to, a Bluetooth™ device, an 802.11 device, a WiFi device, a WiMax device, a WWAN device, cellular communication facilities, or the like.

The communications subsystem 830 may permit data to be exchanged with a network (such as network 115, 160, or 180, to name examples), with other computer systems, with any other devices described herein, or with any combination of network, systems, and devices. According to some embodiments, network 115 (as well as network 160 or 180) might include a local area network (“LAN”), including without limitation a fiber network, an Ethernet network, a Token-Ring™ network, and the like; a wide-area network (“WAN”); a wireless wide area network (“WWAN”); a virtual network, such as a virtual private network (“VPN”); the Internet; an intranet; an extranet; a public switched telephone network (“PSTN”); an infra-red network; a wireless network, including without limitation a network operating under any of the IEEE 802.11 suite of protocols, the Bluetooth™ protocol, or any other wireless protocol; or any combination of these or other networks. In many embodiments, the computer system 800 will further comprise a working memory 835, which can include a RAM or ROM device, as described above.

The computer system 800 may also comprise software elements, shown as being currently located within the working memory 835, including an operating system 840, device drivers, executable libraries, or other code. The software elements may include one or more application programs 845, which may comprise computer programs provided by various embodiments, or may be designed to implement methods and/or configure systems provided by other embodiments, as described herein. Merely by way of example, one or more procedures described with respect to the methods discussed above might be implemented as code or instructions executable by a computer or by a processor within a computer. In an aspect, such code or instructions can be used to configure or adapt a general purpose computer, or other device, to perform one or more operations in accordance with the described methods.

A set of these instructions or code might be encoded and/or stored on a non-transitory computer readable storage medium, such as the storage devices 825 described above. In some cases, the storage medium might be incorporated within a computer system, such as the system 800. In other embodiments, the storage medium might be separate from a computer system—that is, a removable medium, such as a compact disc, or the like. In some embodiments, the storage medium might be provided in an installation package, such that the storage medium can be used to program, configure, and/or adapt a general purpose computer with the instructions/code stored thereon. These instructions might take the form of executable code, which is executable by the computer system 800, or might take the form of source or installable code. The source or installable code, upon compilation, installation, or both compilation and installation, on the computer system 800 might take the form of executable code. Compilation or installation might be performed using any of a variety of generally available compilers, installation programs, compression/decompression utilities, or the like.

It will be apparent to those skilled in the art that substantial variations may be made in accordance with specific requirements. For example, customized hardware—such as programmable logic controllers, field-programmable gate arrays, application-specific integrated circuits, or the like—might also be used. In some cases, particular elements might be implemented in hardware, software (including portable software, such as applets, etc.), or both. Further, connection to other computing devices such as network input/output devices may be employed.

As mentioned above, in one aspect, some embodiments may employ a computer system, such as the computer system 800, to perform methods in accordance with various embodiments of the invention. According to a set of embodiments, some or all of the procedures of such methods might be performed by the computer system 800 in response to processor 810 executing one or more sequences of one or more instructions. The one or more instructions might be incorporated into the operating system 840 or other code that may be contained in the working memory 835, such as an application program 845. Such instructions may be read into the working memory 835 from another computer readable medium, such as one or more of the storage devices 825. Merely by way of example, execution of the sequences of instructions contained in the working memory 835 might cause the one or more processors 810 to perform one or more procedures of the methods described herein.

The terms “machine readable medium” and “computer readable medium,” as used herein, refer to any medium that participates in providing data that causes a machine to operate in a specific fashion. In an embodiment implemented using the computer system 800, various computer readable media might be involved in providing instructions or code to the one or more processors 810 for execution, might be used to store and/or carry such instructions/code such as signals, or both. In many implementations, a computer readable medium is a non-transitory, physical, or tangible storage medium. Such a medium may take many forms, including, but not limited to, non-volatile media, volatile media, and transmission media. Non-volatile media includes, for example, optical disks, magnetic disks, or both, such as the storage devices 825. Volatile media includes, without limitation, dynamic memory, such as the working memory 835. Transmission media includes, without limitation, coaxial cables, copper wire and fiber optics, including the wires that comprise the bus 805, as well as the various components of the communication subsystem 830, or the media by which the communications subsystem 830 provides communication with other devices. Hence, transmission media can also take the form of waves, including without limitation radio, acoustic, or light waves, such as those generated during radio-wave and infra-red data communications.

Common forms of physical or tangible computer readable media include, for example, a floppy disk, a flexible disk, a hard disk, magnetic tape, or any other magnetic medium; a CD-ROM, DVD-ROM, or any other optical medium; punch cards, paper tape, or any other physical medium with patterns of holes; a RAM, a PROM, an EPROM, a FLASH-EPROM, or any other memory chip or cartridge; a carrier wave; or any other medium from which a computer can read instructions or code.

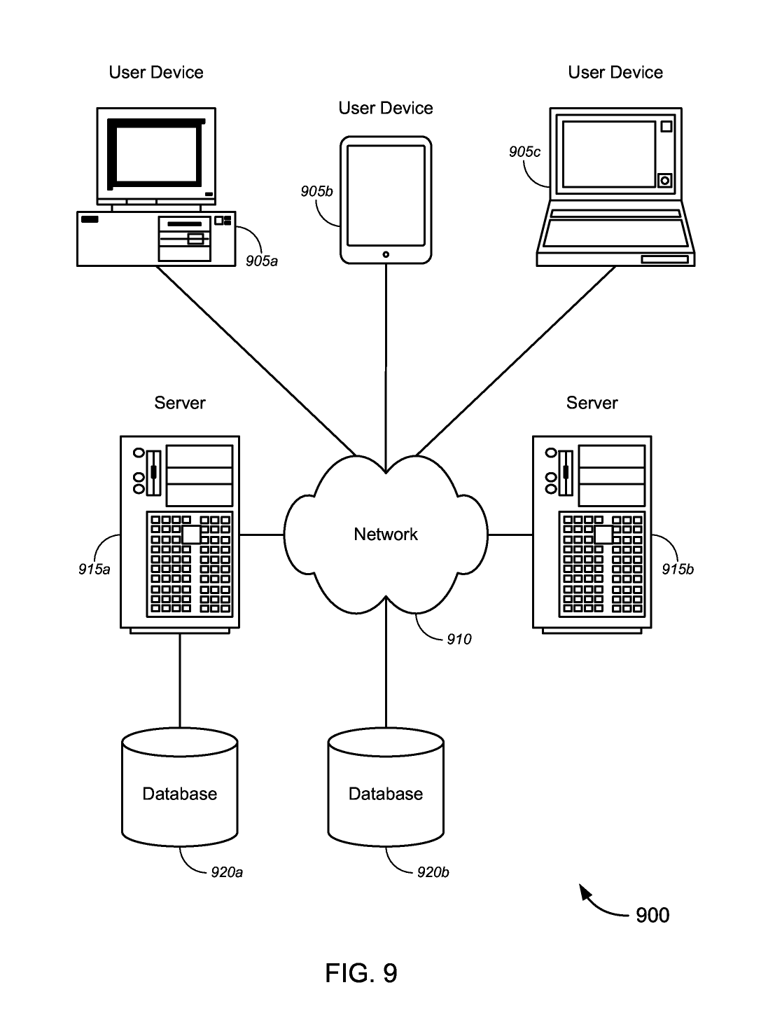

As noted above, a set of embodiments comprises methods and systems for providing and operating a federated e-commerce network. FIG. 9 illustrates a schematic diagram of a system 900 that can be used in accordance with one set of embodiments. The system 900 can include one or more user computers or user devices 905. A user computer or user device 905 can be a general purpose personal computer (including, merely by way of example, desktop computers, tablet computers, laptop computers, handheld computers, and the like, running any appropriate operating system, several of which are available from vendors such as Apple, Microsoft Corp., and the like) and/or a workstation computer running any of a variety of commercially-available UNIX™ or UNIX-like operating systems. A user computer or user device 905 can also have any of a variety of applications, including one or more applications configured to perform methods provided by various embodiments (as described above, for example), as well as one or more office applications, database client and/or server applications, and/or web browser applications. Alternatively, a user computer or user device 905 can be any other electronic device, such as a thin-client computer, Internet-enabled mobile telephone, and/or personal digital assistant, capable of communicating via a network (e.g., the network 910 described below) and/or of displaying and navigating web pages or other types of electronic documents. Although the exemplary system 900 is shown with three user computers or user devices 905, any number of user computers or user devices can be supported.

Certain embodiments operate in a networked environment, which can include a network 910. The network 910 can be any type of network familiar to those skilled in the art that can support data communications using any of a variety of commercially-available (and/or free or proprietary) protocols, including without limitation TCP/IP, SNA™, IPX™, AppleTalk™, and the like. Merely by way of example, the network 910 can include a local area network (“LAN”), including without limitation a fiber network, an Ethernet network, a Token-Ring™ network and/or the like; a wide-area network (“WAN”); a wireless wide area network (“WWAN”); a virtual network, such as a virtual private network (“VPN”); the Internet; an intranet; an extranet; a public switched telephone network (“PSTN”); an infra-red network; a wireless network, including without limitation a network operating under any of the IEEE 802.11 suite of protocols, the Bluetooth™ protocol known in the art, and/or any other wireless protocol; and/or any combination of these and/or other networks. In a particular embodiment, the network might include an access network of the service provider (e.g., an Internet service provider (“ISP”)). In another embodiment, the network might include a core network of the service provider, and/or the Internet.

Embodiments can also include one or more server computers 915. Each of the server computers 915 may be configured with an operating system, including without limitation any of those discussed above, as well as any commercially (or freely) available server operating systems. Each of the servers 915 may also be running one or more applications, which can be configured to provide services to one or more clients 905 and/or other servers 915.

Merely by way of example, one of the servers 915 might be a data server, as described above. The data server might include (or be in communication with) a web server, which can be used, merely by way of example, to process requests for web pages or other electronic documents from user computers 905. The web server can also run a variety of server applications, including HTTP servers, FTP servers, CGI servers, database servers, Java servers, and the like. In some embodiments of the invention, the web server may be configured to serve web pages that can be operated within a web browser on one or more of the user computers 905 to perform methods of the invention.

The server computers 915, in some embodiments, might include one or more application servers, which can be configured with one or more applications accessible by a client running on one or more of the client computers 905 and/or other servers 915. Merely by way of example, the server(s) 915 can be one or more general purpose computers capable of executing programs or scripts in response to the user computers 905 and/or other servers 915, including without limitation web applications (which might, in some cases, be configured to perform methods provided by various embodiments). Merely by way of example, a web application can be implemented as one or more scripts or programs written in any suitable programming language, such as Java™, C, C#™ or C++, and/or any scripting language, such as Perl, Python, or TCL, as well as combinations of any programming and/or scripting languages. The application server(s) can also include database servers, including without limitation those commercially available from Oracle™, Microsoft™, Sybase™, IBM™ and the like, which can process requests from clients (including, depending on the configuration, dedicated database clients, API clients, web browsers, etc.) running on a user computer or user device 905 and/or another server 915. In some embodiments, an application server can perform one or more of the processes for implementing automated cloud expansion and ordering, or the like, as described in detail above. Data provided by an application server may be formatted as one or more web pages (comprising HTML, JavaScript, etc., for example) and/or may be forwarded to a user computer 905 via a web server (as described above, for example). Similarly, a web server might receive web page requests and/or input data from a user computer 905 and/or forward the web page requests and/or input data to an application server. In some cases a web server may be integrated with an application server.

In accordance with further embodiments, one or more servers 915 can function as a file server and/or can include one or more of the files (e.g., application code, data files, etc.) necessary to implement various disclosed methods, incorporated by an application running on a user computer 905 and/or another server 915. Alternatively, as those skilled in the art will appreciate, a file server can include all necessary files, allowing such an application to be invoked remotely by a user computer or user device 905 and/or server 915.

It should be noted that the functions described with respect to various servers herein (e.g., application server, database server, web server, file server, etc.) can be performed by a single server and/or a plurality of specialized servers, depending on implementation-specific needs and parameters.

In certain embodiments, the system can include one or more databases 920. The location of the database(s) 920 is discretionary: merely by way of example, a database 920a might reside on a storage medium local to (and/or resident in) a server 915a (and/or a user computer or user device 905). Alternatively, a database 920b can be remote from any or all of the computers 905, 915, so long as it can be in communication (e.g., via the network 910) with one or more of these. In a particular set of embodiments, a database 920 can reside in a storage-area network (“SAN”) familiar to those skilled in the art. (Likewise, any necessary files for performing the functions attributed to the computers 905, 915 can be stored locally on the respective computer and/or remotely, as appropriate.) In one set of embodiments, the database 920 can be a relational database, such as an Oracle database, that is adapted to store, update, and retrieve data in response to SQL-formatted commands. The database might be controlled and/or maintained by a database server, as described above, for example.

While certain features and aspects have been described with respect to exemplary embodiments, one skilled in the art will recognize that numerous modifications are possible. For example, the methods and processes described herein may be implemented using hardware components, software components, and/or any combination thereof. Further, while various methods and processes described herein may be described with respect to particular structural and/or functional components for ease of description, methods provided by various embodiments are not limited to any particular structural and/or functional architecture but instead can be implemented on any suitable hardware, firmware and/or software configuration. Similarly, while certain functionality is ascribed to certain system components, unless the context dictates otherwise, this functionality can be distributed among various other system components in accordance with the several embodiments.

Moreover, while the procedures of the methods and processes described herein are described in a particular order for ease of description, unless the context dictates otherwise, various procedures may be reordered, added, and/or omitted in accordance with various embodiments. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments are described with—or without—certain features for ease of description and to illustrate exemplary aspects of those embodiments, the various components and/or features described herein with respect to a particular embodiment can be substituted, added and/or subtracted from among other described embodiments, unless the context dictates otherwise. Consequently, although several exemplary embodiments are described above, it will be appreciated that the invention is intended to cover all modifications and equivalents within the scope of the following claims.

What is claimed is:

1. A federated e-commerce network system, comprising:
a federated e-commerce server operated by a federated e-commerce provider in a federated e-commerce network, the federated e-commerce server comprising one or more computers, each comprising one or more processors and a set of instructions executable by the one or more processors to perform one or more operations;
a regional database located in the federated e-commerce network and communicatively coupled to the federated e-commerce server;
a first e-commerce network interface device (“NID”) among a plurality of e-commerce NIDs, the first e-commerce NID comprising one or more network interfaces and being configured to provide communication between a first merchant computer and the federated e-commerce server over the federated e-commerce network, the first merchant computer being located at a first retail location operated by a first merchant and comprising a first merchant database that tracks inventory of the first retail location;
a second e-commerce NID among the plurality of e-commerce NIDs, the second e-commerce NID being configured to provide communication between a second merchant computer and the federated e-commerce server over the federated e-commerce network, the second merchant computer being located at a second retail location operated by a second merchant and comprising a second merchant database that tracks inventory of the second retail location;
wherein the set of instructions comprises instructions to automatically update the regional database, in response to inventory updates being performed by at least one of the first merchant database or the second merchant database.

2. The system of claim 1, wherein one or more of the federated e-commerce server, the first e-commerce NID, or the second e-commerce NID performs one or more gateway functions that provide data transfer between the regional database and one or more of the first merchant database or the second merchant database.

3. The system of claim 2, wherein the one or more gateway functions comprise one or more of synchronizing data between the regional database and one or more of the first merchant database or the second merchant database, translating a local retailer inventory system of one or more of the first merchant computer or the second merchant computer into inventory objects at one or more of the federated e-commerce server or the regional database, accepting manual input of inventory items by one or more of the first merchant or the second merchant, performing logical rules checks on the data prior to data transfer, facilitating handling of audit rejections by one or more of the first merchant or the second merchant, providing a question and answer portal to allow exchange of information regarding inventory, or providing access to a shared sales database located in the federated e-commerce network, wherein the shared sales database is one of the regional database or a database separate from the regional database.

4. The system of claim 1, wherein one or more inventory items stored in the regional database and one or more of the first merchant database or the second merchant database each comprises a hash tag provided by one or more of the first merchant or second merchant that indicates the subject inventory item as a specialty item and how the subject inventory item is useful for a particular specialty area.

5. The system of claim 1, wherein:
the set of instructions further comprises instructions to determine whether inventory of the first retail location has changed, instructions to poll a first retailer inventory system of the first merchant computer in response to a determination that the inventory of the first retail location has changed, and instructions to store inventory changes in the regional database based on results of said polling; and
the set of instructions further comprises instructions to determine whether inventory of the second retail location has changed, instructions to poll a second retailer inventory system of the second merchant computer in response to a determination that the inventory of the second retail location has changed, and instructions to store inventory changes in the regional database based on results of said polling.

6. The system of claim 5, wherein:
the instructions to determine whether inventory of the first retail location has changed includes instructions to determine whether inventory of the first retail location has changed based on analysis of at least one of sales transactions, merchandise tracking system data, business accounts, or merchandise stocking manifests of the first retail location; and
the instructions to determine whether inventory of the second retail location has changed includes instructions to determine whether inventory of the second retail location has changed based on analysis of at least one of sales transactions, merchandise tracking system data, business accounts, or merchandise stocking manifests of the second retail location.

7. The system of claim 1, wherein the first merchant database has stored thereon local pricing information for each item of merchandise listed in the inventory of the first retail location, and wherein the second merchant database has stored thereon local pricing information for each item of merchandise listed in the inventory of the second retail location.

8. The system of claim 1, wherein the set of instructions further comprises:
instructions to establish or maintain a website integrating inventory information stored in the first merchant database and in the second merchant database;
instructions to provide a consumer having access to the website with tools to search consolidated inventory information corresponding to the inventory information stored in the first merchant database and in the second merchant database, the consolidated inventory information being stored in the regional database;
instructions to provide the consumer with tools to purchase, via the website, one or more merchandise items listed in the consolidated inventory information stored in the regional database; and
instructions to update each of the regional database, the first merchant database, and the second merchant database based on the purchase of the one or more merchandise items via the website.

9. The system of claim 8, wherein the set of instructions further comprises:
instructions to provide communication between the federated e-commerce server and one or more payment networks; and
instructions to provide the consumer with payment options associated with the one or more payment networks during purchasing of the one or more merchandise items,
wherein the one or more payment networks include at least one of banking networks, online payment networks, or charge card networks.

10. The system of claim 8, wherein the set of instructions further comprises:
instructions to provide retailer control to each of the first merchant and the second merchant via the federated e-commerce network,
wherein the retailer control includes at least one of changing a sales status of each of the one or more merchandise items listed in the inventory information to indicate whether said each of the one or more merchandise items is a sale item that is available for sale on the website, changing a sale price for each sale item on the website, changing a promotion status of each sale item to indicate whether said each sale item is to be advertised as being one of a discounted item, a clearance item, a best value item, or a featured item.

11. The system of claim 10, wherein the set of instructions further comprises:
instructions to generate advertisements based on at least one of the sales status, the sale price, or promotion status of each sale item; and
instructions to distribute the generated advertisements along one or more advertising channels based on geographic location of each retail location associated with each sale item,
wherein the one or more advertising channels include at least one of television advertisement, advertisement associated with delivery of one or more on-demand content, Internet advertisement, e-mail advertisement, text message advertisement, smart-phone application advertisement, tablet computer application advertisement, online newspaper or magazine advertisement, electronic billboard advertisement, radio advertisement, online group advertisement, live sports event electronic advertisement, or in-store electronic advertisement.

12. The system of claim 8, wherein the set of instructions further comprises:
instructions to identify customer pattern information associated with each customer, based on buying and viewing patterns of each customer on the website;
instructions to store the customer pattern information associated with each customer in the regional database;
instructions to provide each customer with options to create, modify, or delete at least one of one or more wish lists, one or more hate lists, or one or more gift lists;
instructions to generate targeted advertisement for each customer, based on at least one of the customer pattern information, the one or more wish lists, the one or more hate lists, or the one or more gift lists associated with each customer.

13. The system of claim 8, the set of instructions further comprises:
instructions to provide communication between the federated e-commerce server and one or more national or international e-commerce servers associated with one or more national or international e-commerce retailers via one or more national or international e-commerce networks, each of the one or more national or international e-commerce servers being configured to establish or maintain a national or international e-commerce website; and
instructions to send the consolidated inventory information stored in the regional database to the one or more national or international e-commerce servers for presentation and searching, on the national or international e-commerce website, of the one or more merchandise items listed in the consolidated inventory information.

14. A method for providing federated e-commerce functionality among a plurality of retail locations operated by a plurality of merchants, the method comprising:
providing, with a first e-commerce network interface device (“NID”) among a plurality of e-commerce NIDs, communication between a first merchant computer and a federated e-commerce server over a federated e-commerce network, the first merchant computer being located at a first retail location among the plurality of retail locations, the first retail location being operated by a first merchant among the plurality of merchants, the first merchant computer comprising a first merchant database that tracks inventory of the first retail location, the federated e-commerce server being operated by a federated e-commerce provider;
providing, with a second e-commerce NID among the plurality of e-commerce NIDs, communication between a second merchant computer and the federated e-commerce server over the federated e-commerce network, the second merchant computer being located at a second retail location among the plurality of retail locations, the second retail location being operated by a second merchant among the plurality of merchants, the second merchant computer comprising a second merchant database that tracks inventory of the second retail location;
automatically updating, with the federated e-commerce server, a regional database that is communicatively coupled to the federated e-commerce server, in response to inventory updates being performed by at least one of the first merchant database or the second merchant database, the regional database being located in the federated e-commerce network.

15. The method of claim 14, wherein one or more of the federated e-commerce server, the first e-commerce NID, or the second e-commerce NID performs one or more gateway functions that provide data transfer between the regional database and one or more of the first merchant database or the second merchant database.

16. The method of claim 15, wherein the one or more gateway functions comprise one or more of synchronizing data between the regional database and one or more of the first merchant database or the second merchant database, translating a local retailer inventory system of one or more of the first merchant computer or the second merchant computer into inventory objects at one or more of the federated e-commerce server or the regional database, accepting manual input of inventory items by one or more of the first merchant or the second merchant, performing logical rules checks on the data prior to data transfer, facilitating handling of audit rejections by one or more of the first merchant or the second merchant, providing a question and answer portal to allow exchange of information regarding inventory, or providing access to a shared sales database located in the federated e-commerce network, wherein the shared sales database is one of the regional database or a database separate from the regional database.

17. The method of claim 14, wherein one or more inventory items stored in the regional database and one or more of the first merchant database or the second merchant database each comprises a hash tag provided by one or more of the first merchant or second merchant that indicates the subject inventory item as a specialty item and how the subject inventory item is useful for a particular specialty area.

18. The method of claim 14, wherein:
automatically updating the regional database, in response to inventory updates of inventory information of the first retail location performed by the first merchant database, includes determining whether inventory of the first retail location has changed, polling a first retailer inventory system of the first merchant computer in response to a determination that the inventory of the first retail location has changed, and storing inventory changes in the regional database based on results of said polling; and
automatically updating the regional database, in response to inventory updates of inventory information of the second retail location performed by the second merchant database, includes determining whether inventory of the second retail location has changed, polling a second retailer inventory system of the second merchant computer in response to a determination that the inventory of the second retail location has changed, and storing inventory changes in the regional database based on results of said polling.

19. The method of claim 18, wherein:
determining whether inventory of the first retail location has changed includes determining whether inventory of the first retail location has changed based on analysis of at least one of sales transactions, merchandise tracking system data, business accounts, or merchandise stocking manifests of the first retail location; and
determining whether inventory of the second retail location has changed includes determining whether inventory of the second retail location has changed based on analysis of at least one of sales transactions, merchandise tracking system data, business accounts, or merchandise stocking manifests of the second retail location.

20. The method of claim 14, wherein the first merchant database has stored thereon local pricing information for each item of merchandise listed in the inventory of the first retail location, and wherein the second merchant database has stored thereon local pricing information for each item of merchandise listed in the inventory of the second retail location.

21. The method of claim 14, further comprising:
establishing or maintaining, with the federated e-commerce server, a website integrating inventory information stored in the first merchant database and in the second merchant database;
providing, with the federated e-commerce server, tools for a consumer having access to the website to search consolidated inventory information corresponding to the inventory information stored in the first merchant database and in the second merchant database, the consolidated inventory information being stored in the regional database;
providing, with the federated e-commerce server, tools for the consumer to purchase, via the website, one or more merchandise items listed in the consolidated inventory information stored in the regional database; and
updating, with the federated e-commerce server, each of the regional database, the first merchant database, and the second merchant database based on the purchase of the one or more merchandise items via the website.

22. The method of claim 21, further comprising:
providing, with the federated e-commerce server, communication between the federated e-commerce server and one or more payment networks; and
providing, with the federated e-commerce server, payment options to the consumer during purchasing of the one or more merchandise items, the payment options being associated with the one or more payment networks,
wherein the one or more payment networks include at least one of banking networks, online payment networks, or charge card networks.

23. The method of claim 21, further comprising:
providing, with the federated e-commerce server, retailer control to each of the plurality of merchants via the federated e-commerce network,
wherein the retailer control includes at least one of changing a sales status of each of the one or more merchandise items listed in the inventory information to indicate whether said each of the one or more merchandise items is a sale item that is available for sale on the website, changing a sale price for each sale item on the website, changing a promotion status of each sale item to indicate whether said each sale item is to be advertised as being one of a discounted item, a clearance item, a best value item, or a featured item.

24. The method of claim 23, further comprising:
generating, with the federated e-commerce server, advertisements based on at least one of the sales status, the sale price, or promotion status of each sale item; and
distributing, with the federated e-commerce server, the generated advertisements along one or more advertising channels based on geographic location of each retail location associated with each sale item,
wherein the one or more advertising channels include at least one of television advertisement, advertisement associated with one or more on-demand content delivery, Internet advertisement, e-mail advertisement, text message advertisement, smart-phone application advertisement, tablet computer application advertisement, online newspaper or magazine advertisement, electronic billboard advertisement, radio advertisement, online group advertisement, live sports event electronic advertisement, or in-store electronic advertisement.

25. The method of claim 21, further comprising:
identifying, with the federated e-commerce server, customer pattern information associated with each customer, based on buying and viewing patterns of each customer on the website;
storing, with the federated e-commerce server, the customer pattern information associated with each customer in the regional database;
providing, with the federated e-commerce server, options to each customer to create, modify, or delete at least one of one or more wish lists, one or more hate lists, or one or more gift lists; and
generating, with the federated e-commerce server, targeted advertisement for each customer, based on at least one of the customer pattern information, the one or more wish lists, the one or more hate lists, or the one or more gift lists associated with each customer.

26. The method of claim 21, further comprising:
providing, with the federated e-commerce server, communication between the federated e-commerce server and one or more national or international e-commerce servers associated with one or more national or international e-commerce retailers via one or more national or international e-commerce networks, each of the one or more national or international e-commerce servers being configured to establish or maintain a national or international e-commerce website; and
sending, with the federated e-commerce server, the consolidated inventory information stored in the regional database to the one or more national or international e-commerce servers for presentation and searching, on the national or international e-commerce website, of the one or more merchandise items listed in the consolidated inventory information.

27. An e-commerce network interface device (“NID”), comprising:
a processor;
one or more network interfaces;
a non-transitory computer readable medium having stored thereon a set of instructions executable by the processor to perform one or more operations, the set of instructions comprising:
instructions to provide communication between a first merchant computer and a federated e-commerce server over the federated e-commerce network, the first merchant computer being located at a first retail location among the plurality of retail locations, the first retail location being operated by a first merchant among a plurality of merchants, the first merchant computer comprising a first merchant database that tracks inventory of the first retail location, the federated e-commerce server being operated by the federated e-commerce provider;
instructions for sending inventory updates of the first retail location to the federated e-commerce server over the federated e-commerce network, in response to a determination that inventory of the first retail location has changed.
